(19) United States
(12) Patent Application Publication
(10) Pub. No.: US 2023/0173343 A1
(43) Pub. Date: Jun. 8, 2023

(54) VIDEO CONFERENCING FOR VIRTUAL PERSONAL TRAINING

(71) Applicant: FlexIt Inc., New York, NY (US)

(72) Inventors: Austin Cohen, New York, NY (US); Justin Turetsky, New York, NY (US)

(21) Appl. No.: 17/871,630

(22) Filed: Jul. 22, 2022

Related U.S. Application Data
(60) Provisional application No. 63/224,613, filed on Jul. 22, 2021.

(51) Int. Cl. A63B 24/00; H04L 65/401; H04L 65/1069; H04L 67/306; A63B 71/06; G06Q 10/02

(52) U.S. Cl. CPC A63B 24/0075; H04L 65/4015; H04L 65/1069; H04L 67/306; A63B 71/0622; G06Q 10/02; A63B 2071/0638; A63B 2071/0694; A63B 2024/0068; A63B 2225/20

(57) ABSTRACT

In an embodiment, a method, in a data processing system comprising a processor and a memory, for virtual personal training is disclosed. The method comprises loading, by a server, a virtual personal training landing screen to a client device, receiving, by the server, login information of a user account from the client device, authenticating, by the server, a client user based on the login information, loading, by the server, a client user profile associated with the user account and monitoring, by the server, for function selection from the client device. The function selection includes requesting one of retrieving a health profile, accessing a trainer scheduler, joining a live communication session, and loading video workouts.

### CROSS REFERENCE TO RELATED APPLICATIONS

This application claims the benefit of U.S. Provisional Patent Application No. 63/224,613, entitled “VIDEO CONFERENCING FOR VIRTUAL PERSONAL TRAINING,” filed on Jul. 22, 2021, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

The disclosed embodiments relate to video conferencing systems and, in particular, video conferencing system for virtual personal training.

Personal training provides a targeted wellness experience to individuals with a focus on achieving health goals and benefits. Often an individual needs to physically meet up with a personal trainer either in-home or at a fitness facility in order to take advantage of the benefits that the personal training provides. In some cases, attending or scheduling such a meet up with a personal trainer may be challenging.

### SUMMARY

In an embodiment, a method, in a data processing system comprising a processor and a memory, for virtual personal training is disclosed. The method comprises loading, by a server, a virtual personal training landing screen to a client device, receiving, by the server, login information of a user account from the client device, authenticating, by the server, a client user based on the login information, loading, by the server, a client user profile associated with the user account and monitoring, by the server, for function selection from the client device. The function selection includes requesting one of retrieving a health profile, accessing a trainer scheduler, joining a live communication session, and loading video workouts.

In some embodiments, the client user profile screen includes information of upcoming sessions, a monthly calendar, and training plans.

In an embodiment, retrieving the health profile comprises retrieving data associated with the client user to track progress and log measurements.

In another embodiment, accessing the trainer scheduler comprises reserving one or more sessions with trainers.

In some embodiments, the method further comprises generating a real-form correction screen that allows a trainer client device to draw or add shapes to a session screen as a tool for emphasizing mistakes, form, posture, and show in real time to the client user.

In another embodiment, the method further comprises loading a trainer account view. In an embodiment, the trainer account view includes client management, upcoming sessions, a trainer calendar, availability setting, and client information including profiles, trainer notes, health profile, and workout history.

In an embodiment, a virtual personal training system is disclosed. The virtual personal training system comprises a conference server coupled to the server. The conference server is configured to connect at least one client device to a trainer device in a live audio/video communication session based on a schedule. The virtual personal training system further comprises a server coupled to one or more client devices and one or more trainer devices. The server is configured to receive a request from the at least one client device to reserve the live audio/video communication session, create a reservation in the schedule based on the request and instruct the conference server to join the at least one client device to the trainer device in the live audio/video communication session.

In some embodiments, the server is configured to generate a trainer search page including a browse trainers option to search for trainers.

In another embodiment, the trainer search page includes trainer introduction videos and trainer profiles.

In an embodiment, the server is configured to generate reservations for individual sessions or recurring sessions.

The foregoing summary is illustrative only and is not intended to be in any way limiting. The above-described embodiments may be combined in any way without departing from the scope of the present application. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 illustrates a computing system according to an embodiment.

FIGS. 2 through 55 illustrate exemplary pages of a website provided by a web server of a virtual personal training system according to an embodiment.

FIGS. 56 through 75 illustrate exemplary screens generated by a virtual personal training system client application according to an embodiment.

FIGS. 76 through 82 illustrate exemplary screens generated by a virtual personal training system trainer application according to an embodiment.

FIG. 83 illustrates an exemplary virtual storefront according to an embodiment.

FIG. 84 illustrates an exemplary wall client device according to an embodiment.

FIG. 85 illustrates an exemplary standing client device according to an

embodiment.

FIGS. 86 through 89 illustrate exemplary screens of a virtual personal training system application executed on a wall, mountable, or standing client device according to an embodiment.

FIG. 90 illustrates a flowchart of a method for virtual personal training according to an embodiment.

### DETAILED DESCRIPTION

Subject matter will now be described more fully hereinafter with reference to the accompanying drawings, which form a part hereof, and which show, by way of illustration, exemplary embodiments which may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the disclosed embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The present application discloses a video conferencing system for virtual personal training. The disclosed video conferencing system may include video conferencing functionality and software that provide a holistic wellness experience encompassing one-on-one personal training, guided workouts (via a workout builder/Connected Training™ platform), nutrition planning, an integrated store (featuring equipment, apparel, and other fitness and wellness offerings), by-the-minute access to thousands of gyms, and other wellness offerings (e.g., stretching, recovery, physical therapy, yoga, meditation and more), as well as white label solution creations of the platform. The various components come together to offer an unparalleled experience catering to every facet of the individual's fitness journey. According to one embodiment, a one-on-one personal training component may allow a trainer to instruct, motivate, and guide a client user towards progress with their fitness routine due to a program that the trainer can provide for them, all while not physically being in the same space. Participants can add friends to join sessions with them. Additionally, the disclosed system may include an end to end technology platform that handles all parts of a virtual personal training experience—from liability, insurance, to payment processing and scheduling, calendar invitations for user and trainer, the actual session delivery, and tools such as trainer notes, workout builder, live drawing, and more. The disclosed video conferencing system includes functionalities that provide special camera views, the ability for trainers to project short video clips of perfectly performed exercises onto the screen, the ability for trainers to live draw on the screen, take notes within the system platform, take screenshots, a stopwatch, and a timer, among other features. Client users and trainers may be connected through the disclosed video conferencing system and communicate with one another via messages in advance of a session to exchange information, available equipment, etc. Trainers may be provided from a diverse network of certified top tier trainers throughout the country, assuring that at any given date or time it can be possible to have a fitness session with a qualified trainer through the disclosed video conferencing system.

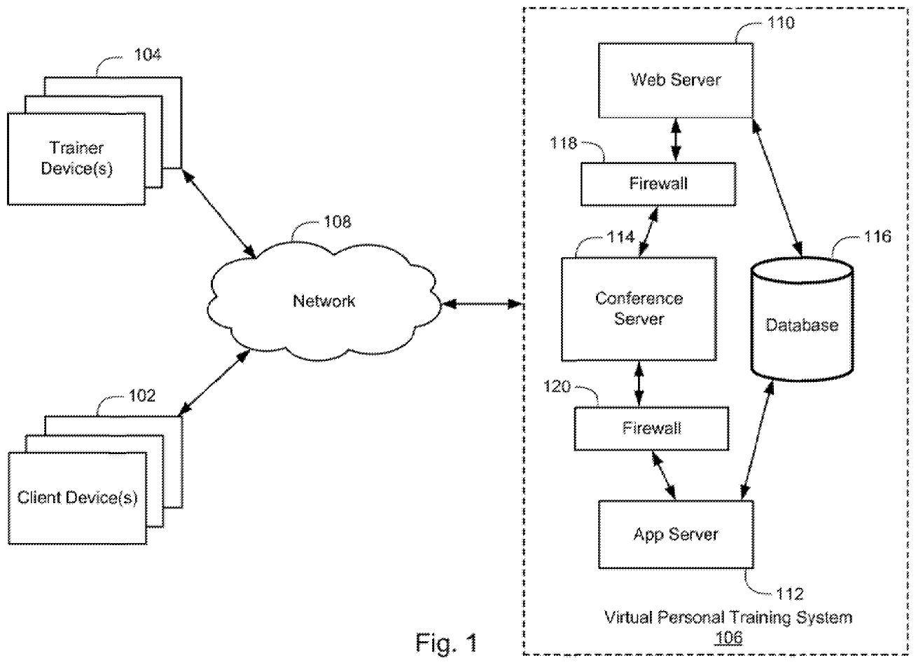

FIG. 1 illustrates a computing system according to an embodiment. The system presented in FIG. 1 includes client device(s) 102, trainer device(s) 104, virtual personal training system 106, and network 108. Client device(s) 102 and trainer device(s) 104 may comprise computing devices (e.g., desktop computers, television devices, terminals, laptops, personal digital assistants (PDA), cellular phones, smartphones, tablet computers, standalone devices built for virtual personal training/virtual personal training systems, smart watches and smart wearable devices, or any computing device having a central processing unit and memory unit capable of connecting to a network). Client device(s) 102 and trainer device(s) 104 may also comprise a graphical user interface (GUI) or a browser application provided on a display (e.g., monitor screen, LCD or LED display, projector, etc.).

The client device(s) 102 and trainer device(s) 104 may vary in terms of capabilities or features. For example, a web-enabled client/trainer device may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display. Client device(s) 102 and trainer device(s) 104 may also include or execute an application to communicate content, such as, for example, textual content, multimedia content, or the like. The client device(s) 102 and trainer device(s) 104 may also include or execute an application to perform a variety of possible tasks, such as browsing, searching, playing various forms of content, including locally stored or streamed video, or games.

The client device(s) 102 and trainer device(s) 104 may include or execute a variety of operating systems, including a personal computer operating system, such as a Windows, Mac OS or Linux, or a mobile operating system, such as iOS, Android, or Windows Phone, or the like. The client device(s) 102 and trainer device(s) 104 may include or may execute a variety of possible applications, such as a client software application enabling communication with other devices, such as communicating one or more messages, such as via email, short message service (SMS), multimedia message service (MMS), or messages on social network platforms including, for example, Facebook, LinkedIn, Twitter, Pinterest, Snapchat, or Instagram, to provide only a few possible examples. The term “social network” refers generally to a network of individuals, such as acquaintances, friends, family, colleagues, or co-workers, coupled via a communications network or via a variety of sub-networks.

Network 108 may be any suitable type of network allowing transport of data communications across thereof. The network 108 may couple devices so that communications may be exchanged, such as between servers and client devices or other types of devices, including between wireless devices coupled via a wireless network, for example. Network 108 may also include mass storage, such as network attached storage (NAS), a storage area network (SAN), cloud computing and storage, or other forms of computer or machine readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from client/trainer devices may be encrypted using, for example, the Advanced Encryption Standard (AES) with a 128, 192, or 256-bit key size, or any other encryption standard known in the art. Additionally, data transmitted to and from the conference server 114 are monitored and controlled by firewalls 118 and 120. Firewalls 118 and 120 allow or block specific traffic (e.g., malware and attacks) based on a defined set of security rules to protect the web server 110 and app server 112.

Virtual personal training system 106 includes web server 110, app server 112, conference server 114, and database 116. Web server 110 may comprise hardware, software, cloud computing resources, or a combination thereof configured to accept and fulfill Hypertext Transfer Protocol (HTTP) requests from client device(s) 102 and trainer device(s) 104 over network 108 relating to virtual personal training functionality via a website (HTML pages, files, images, video, and so on). Similarly, app server 112 may comprise hardware, software, cloud computing resources, or a combination thereof configured to provide the same or similar virtual personal training functionalities as provided by the web server 110 but instead rendered through logic, executable instructions, or code accessed via a virtual personal training client application program installed on client device(s) 102 and trainer device(s) 104. Virtual personal training functionality may comprise user account registration, profile creation, workout/training information and media, fitness quizzes, session scheduling, and live audio/video communication sessions between client device(s) 102 and trainer device(s) 104. For example, client device(s) 102 and trainer device(s) 104 may create accounts and log in to virtual personal training system 106 through web server 110 or app server 112. Database 116 may be used by web server 110 and app server 112 to store and retrieve the accounts created by client device(s) 102 and trainer device(s) 104.

Client device(s) 102 may request virtual personal training content by accessing workout/training media or joining live audio/video communication sessions with trainer device(s) 104. Trainer device(s) 104 may provide or contribute to the personal training content by uploading workout/training media to the web server 110 or app server 112 and participating in live audio/video communication sessions. Live audio/video communication sessions may comprise a conference connection between client device(s) 102 and trainer device(s) 104 during sessions reserved by client device(s) 102 with accounts of trainer device(s). The live audio/video communication sessions may be reserved through web server 110 or app server 112 and facilitated by conference server 114. Reservations may be created and stored in database 116. That is, conference server 114 receives instructions from web server 110 or app server 112 to join client device(s) 102 with trainer device(s) 104 in a conference session based on schedules created through web server 110 or app server 112 and stored in database 116.

The conference server 114 may comprise hardware, software, cloud computing resources, or a combination thereof, communicatively coupled to web server 110 or app server 112. Conference server 114 is configured to support web conferencing between client device(s) 102 and trainer device(s) 104 over network 108 by using Internet technologies, such as TCP/IP connections, Voice over Internet Protocol, etc. A conference connection may allow real-time point-to-point communications as well as multicast communications from one or more of trainer device(s) 104 to one or more of client device(s) 102. Live audio/video communication sessions may include data streams of text-based messages (e.g., Real-time Chat (RTC) or live chat), voice and video chat to be shared simultaneously, across geographically dispersed locations.

Servers, as described herein, may vary widely in configuration or capabilities but are comprised of at least a special-purpose digital computing device including at least one or more central processing units and memory. A server may also include one or more of mass storage devices, power supplies, wired or wireless network interfaces, input/output interfaces, and operating systems, such as Windows Server, Mac OS X, Unix, Linux, FreeBSD, or the like. In an example embodiment, a server may include or have access to memory for storing instructions or applications for the performance of various functions and a corresponding processor for executing stored instructions or applications. For example, the memory may store an instance of the server configured to operate in accordance with the disclosed embodiments.

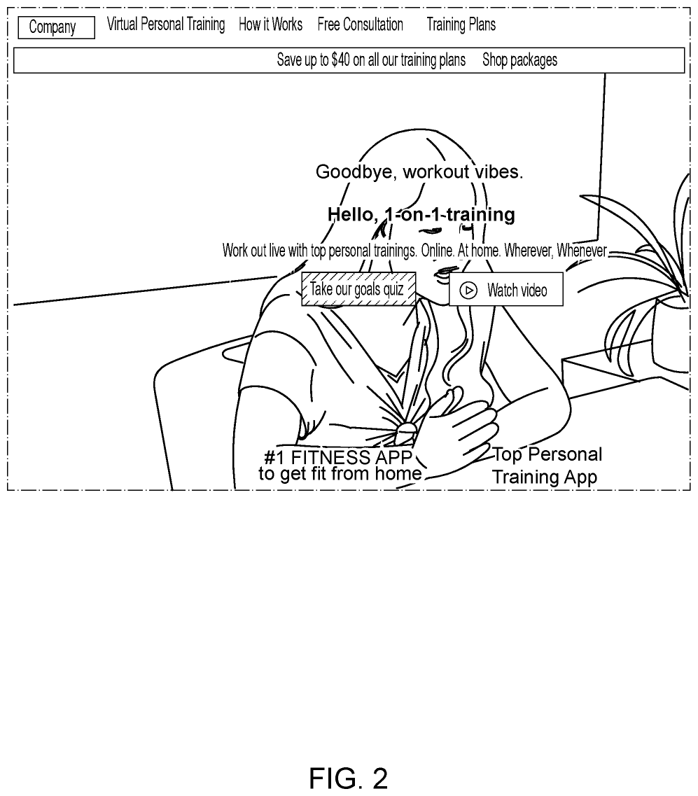

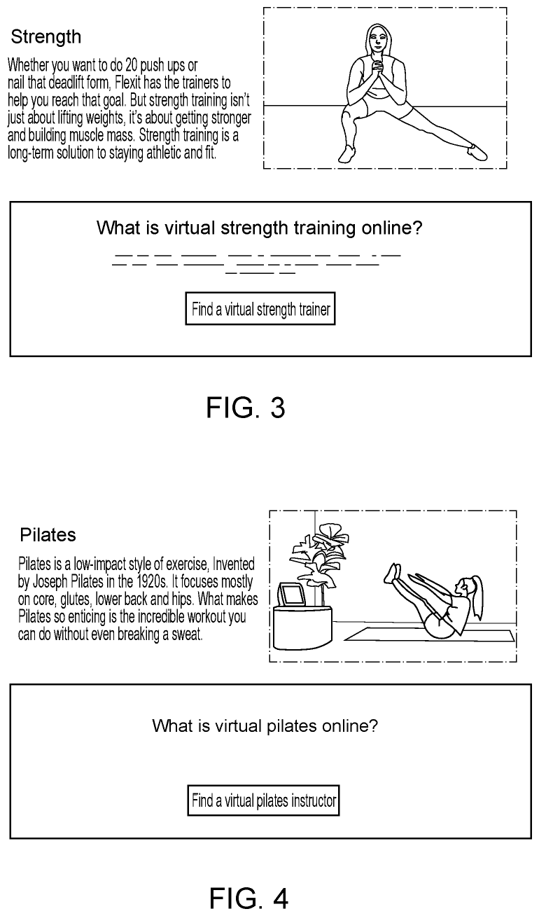

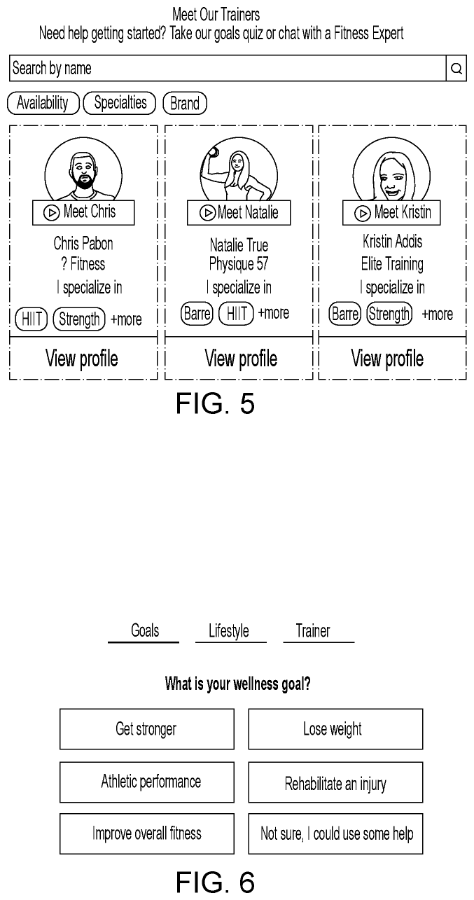

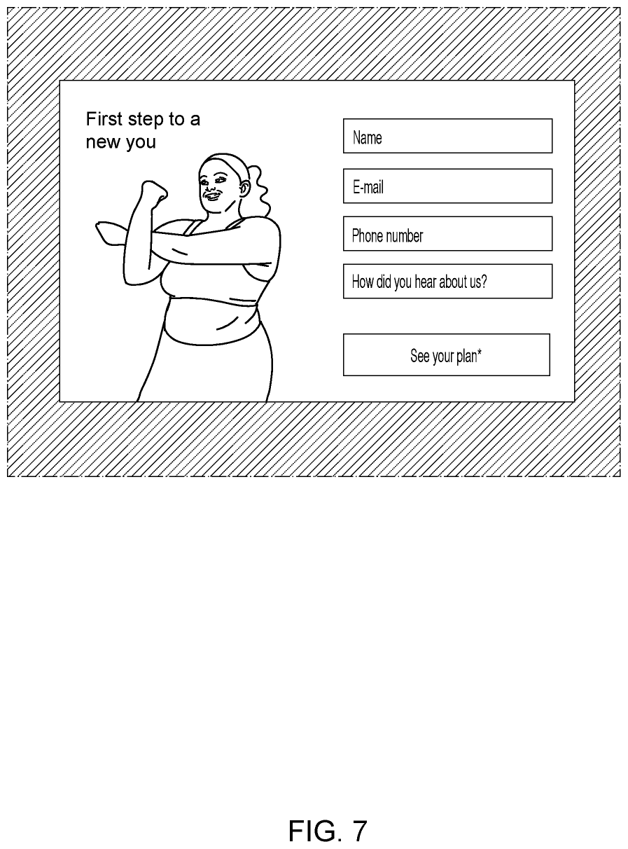

FIG. 2 presents an exemplary landing page of a website provided by a web server of a virtual personal training system according to an embodiment. A user of a client device may arrive at the website either organically or through an ad, generally landing on one of a plurality of paths as disclosed herein. A first path may comprise a main flow where the client user lands on a home page and is greeted with a prompt to learn more about the different types of workouts, view all trainers, talk to a fitness expert, or take a goals quiz. FIGS. 3 and 4 present exemplary web pages on the website providing information on different types of workouts. Examples of workouts that may be presented by the website may include strength, yoga, pilates, and High-intensity interval training (HIIT). A client user can learn more about the different types of workouts that a trainer can provide for them. A client user can choose to view all the trainers that the disclosed virtual personal training system has on its platform via an interface as illustrated in FIG. 5. The client user can search for a specific trainer, or filter by a brand, specialty or based on a trainer's availability. A client user can also choose to take a goals quiz on the disclosed website, as shown in FIG. 6. The goals quiz may include various questions designed to determine, among other things, the best trainer and plan for a client user. The goals quiz may be designed as a focus for capturing leads, as the client user is greeted with a promotion after the quiz to provide their contact information (FIG. 7) for a special offer.

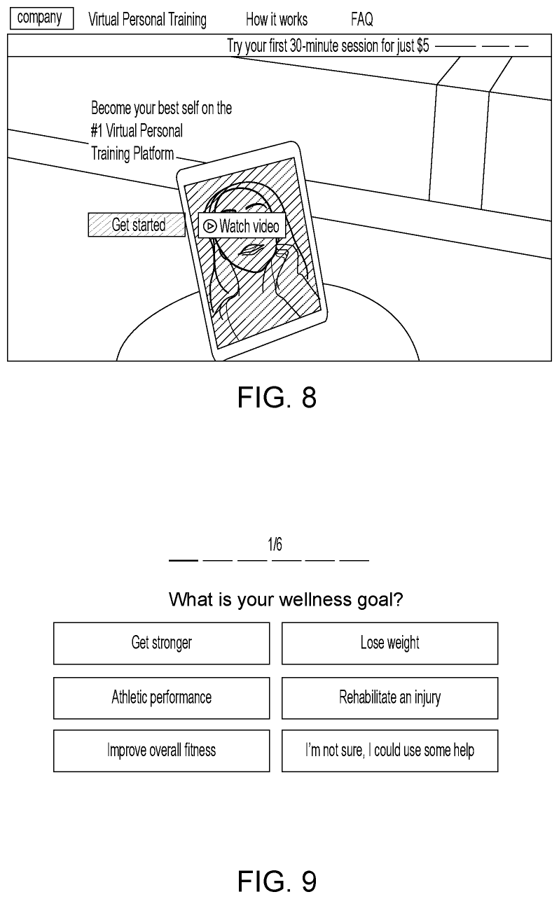

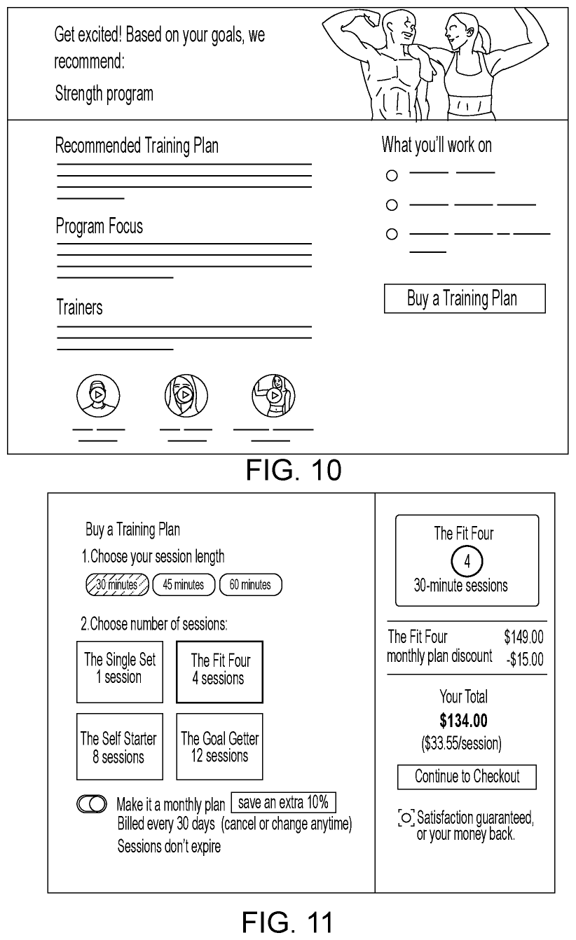

A client user can also view the virtual personal training system website (FIG. 8) according to a singular path for the client user to navigate through, beginning with a more in depth goals quiz, as illustrated in FIG. 9. Rather than viewing a list of all trainer users, the results of the goals quiz is used to generate a page (FIG. 10) with specific trainers that best fit the results of this quiz, along with a suggested training plan (FIG. 11) based on the frequency the client user selected in the quiz.

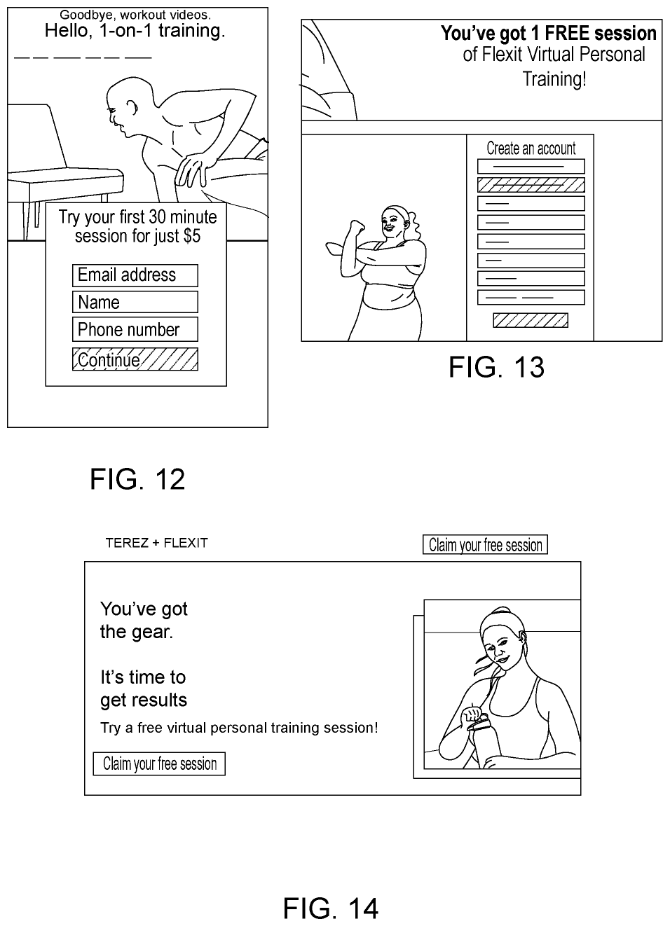

A third path of arriving at the disclosed website may comprise targeted ad landing pages. The targeted ad landing pages may comprise promotional landing pages that are designed around special offers. FIG. 12 presents an exemplary landing page including a promotional offer that can be used as part of a larger campaign to target client users that were at an in-person event, or introduced from partners, influencers, etc., as a means of capturing lead information. FIG. 13 presents another landing page where a VIP client user (or clients coming from advertisements, partners, or influencers, etc.) can use a concierge service to create an account and the account will automatically receive a free single session package. The disclosed virtual personal training system may then suggest available trainers for the client user based on when he / she is looking to train and reserve for them. Alternatively, a client user may be solicited through pages as illustrated in FIG. 14, that may be featured on websites of partners and direct users to the disclosed virtual personal training system website. The disclosed virtual personal training system may further include a network of partners with customized landing pages as a means of capturing potential clients.

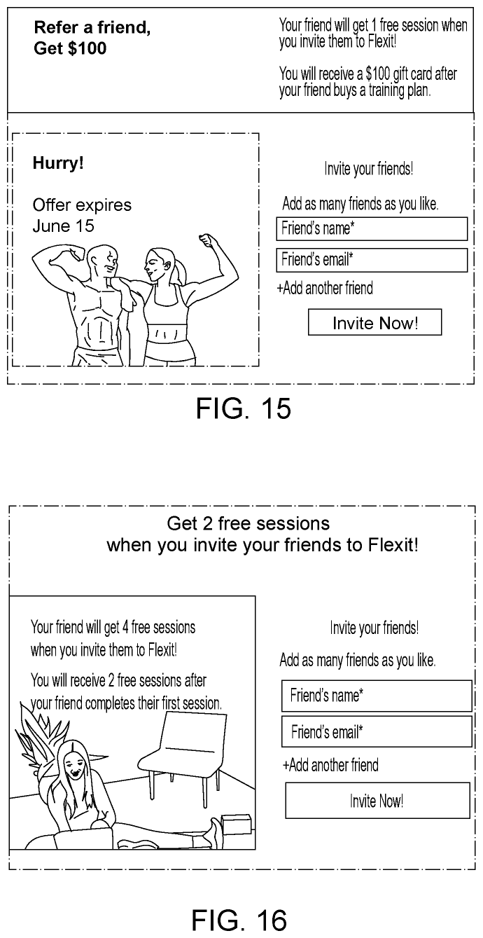

A fourth path of arriving at the disclosed website may comprise referrals. FIGS. 15 and 16 present exemplary referral promotions generated by the disclosed virtual personal training system according to an embodiment. The referral promotions may be presented on the virtual personal training system website or as advertisements on third-party websites. The virtual personal training system may also include a referral system that generates promotions in client users' accounts to entice client users to refer their friends to receive bonus free sessions (i.e., live audio/video communication sessions with trainers).

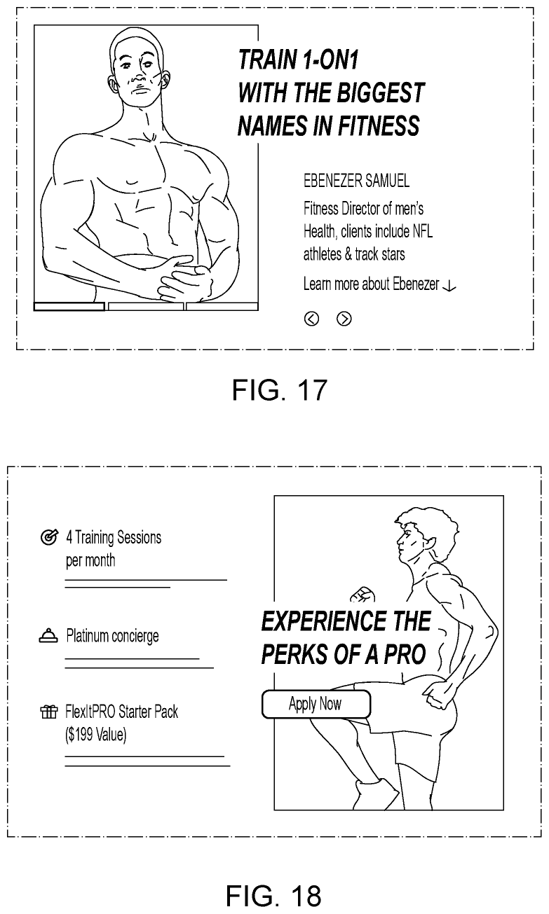

According to one embodiment, a client user can also receive a special invitation to a professional or “pro” version of the disclosed virtual personal training system. FIGS. 17 and 18 present exemplary benefits of an ultra premium version of the virtual personal training system which may include an exclusive training program that pairs client users with personal trainer influencers and personalities (e.g., celebrity trainers who have worked with professional athletes, actors, and teams). Trainers that participate in the professional virtual personal training system platform may be highly skilled, highly specialized trainers that typically train A-list celebrities.

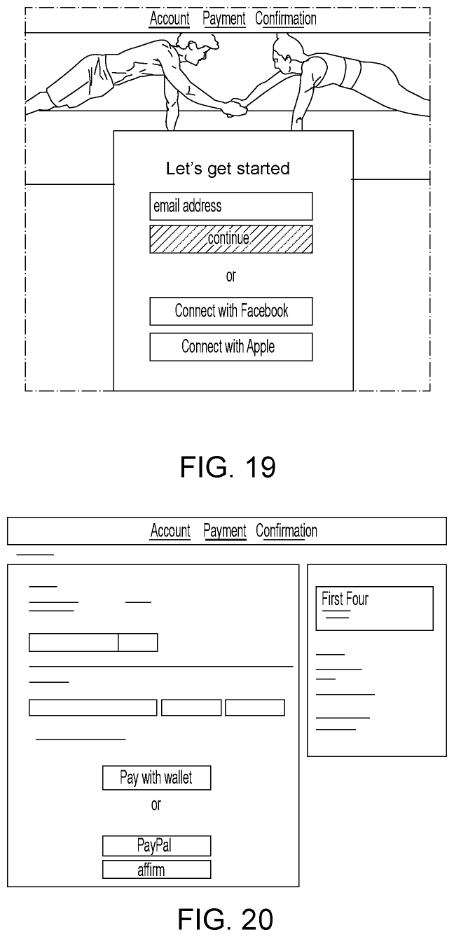

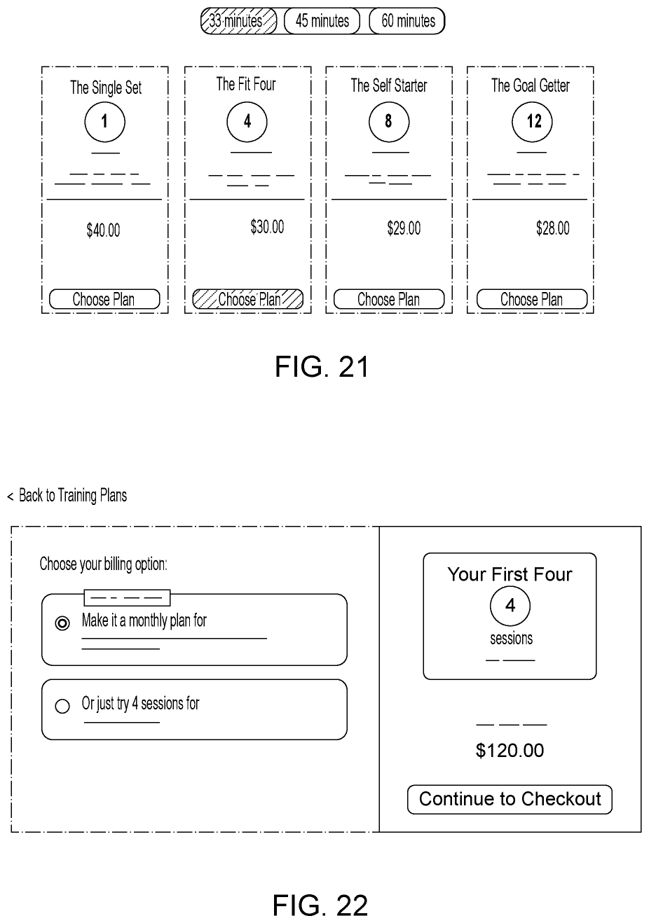

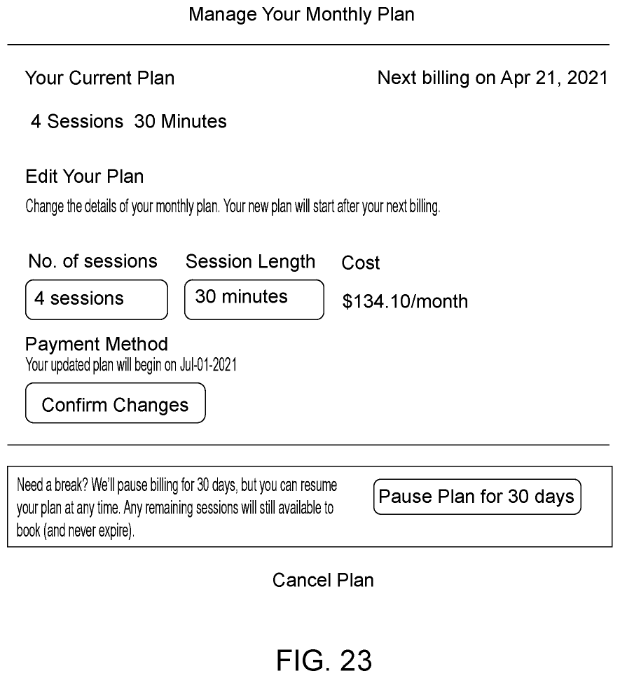

Referring to FIG. 19, a client user can create an account multiple ways including from promotional lead in or referral page, during a checkout process, on a virtual personal training system application, through social media or networking sites (e.g., single sign-on (“SSO”)), or on the login page. A client user can choose their method of payment (FIG. 20), and can choose a one off package purchase, or opt to purchase a monthly training plan. When a client user creates an account, the virtual personal training system may provide the client user with an option to purchase a training plan. As illustrated in FIG. 21, training plans may offer a variety of sessions per month. Additionally, client users may choose to purchase training plans that are either recurring (e.g., a monthly plan) or a one-time purchase, as shown in FIG. 22. Client users can then manage their monthly sessions directly in their account, including changing their plans, pausing, or canceling (FIG. 23).

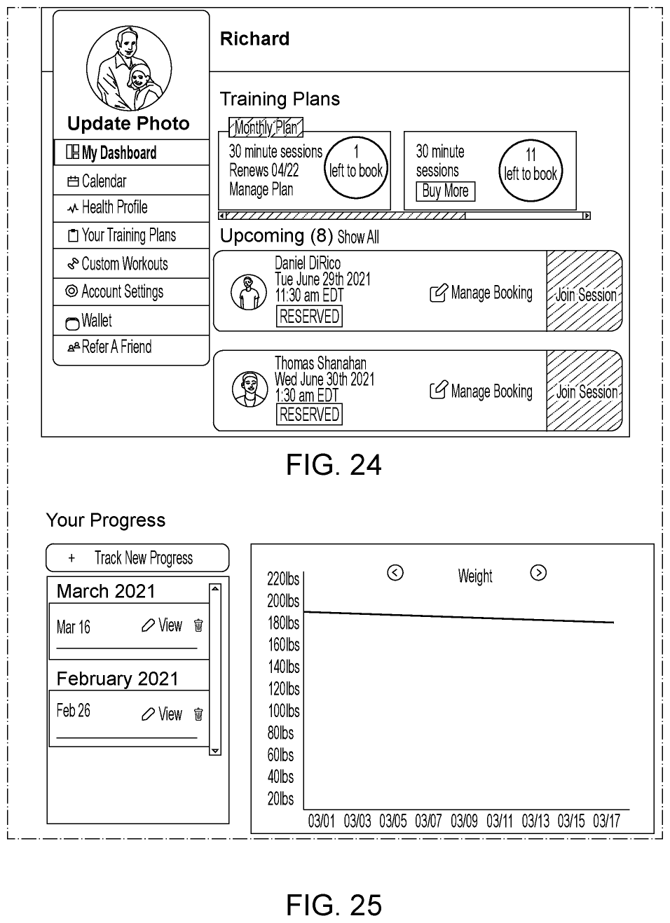

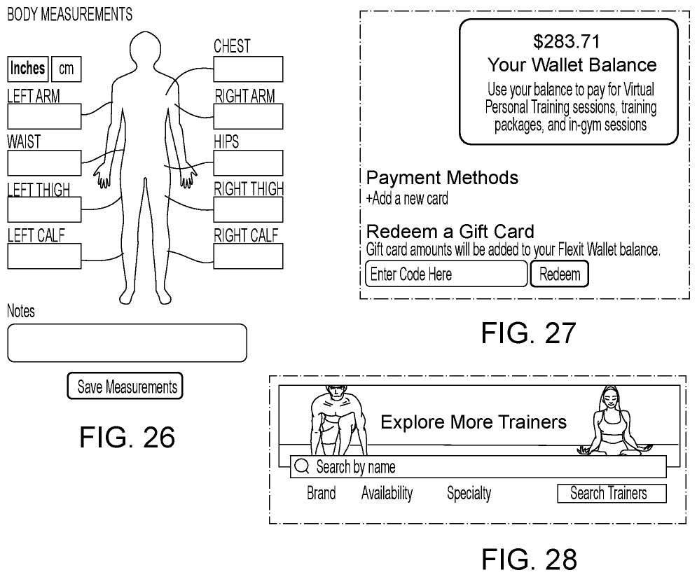

FIG. 24 presents an exemplary client user account page according to an embodiment. The client user account page may allow the client user to view their upcoming sessions, view their monthly calendar on the client user account, add sessions to personal calendars, link personal calendars to the virtual personal training system such that sessions are automatically updated on personal calendars, and manage their monthly training plans. The client user account page may include a health profile generated by the virtual personal training system to allow a client user to track their progress, enter information pertinent to their training sessions, and log their measurements as illustrated in FIGS. 25 and 26. The client user account page may further allow client users to view their wallet balance used for in-gym and virtual sessions, or redeem a gift card (FIG. 27).

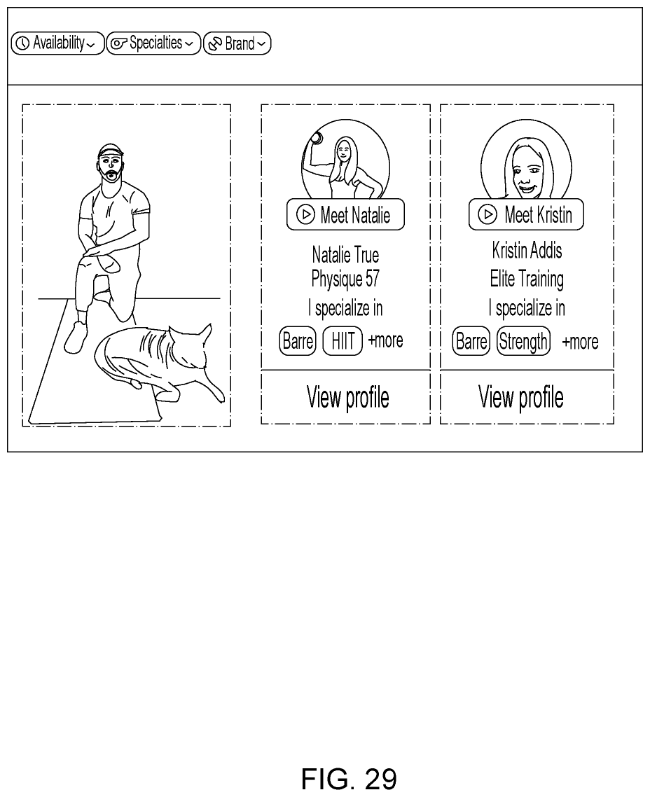

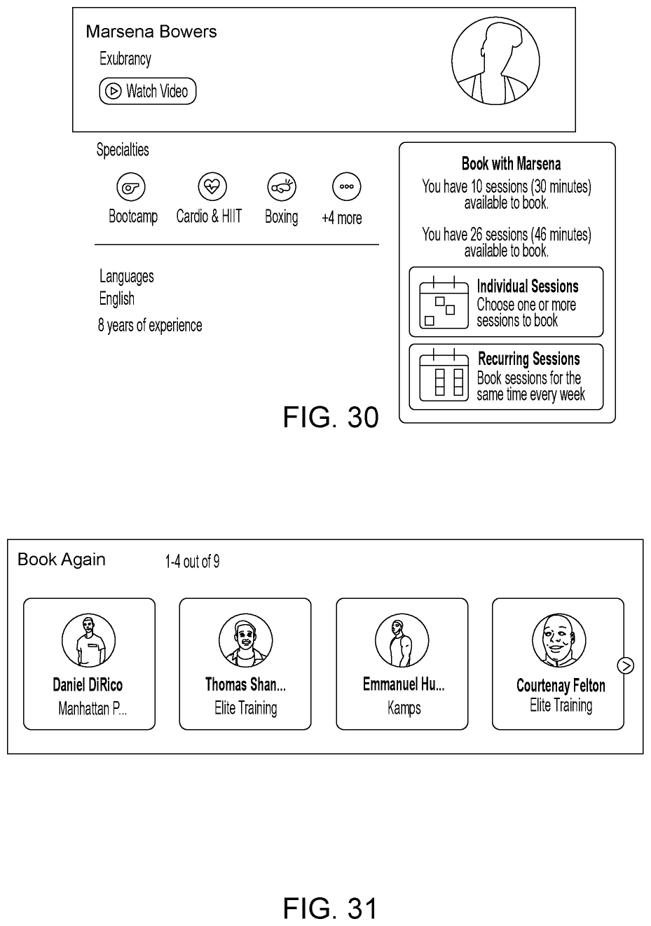

Reserving a session can also be done directly through a client user's account. For example, if the client user is looking for a new trainer, they may use a “browse trainers” option in a trainer search page, as illustrated in FIG. 28, from their client user account page. Client users may search and view a list of trainers that meet selected availability, specialty selections, or other search filters. FIG. 29 presents exemplary trainer search results in a trainer search page according to an embodiment. The client user can watch a video of the trainer introducing themselves from the trainer search page. The client user can view a trainer's profile (e.g., FIG. 30). As shown in FIG. 31, a client user can also choose from a list of trainers that they have previously reserved.

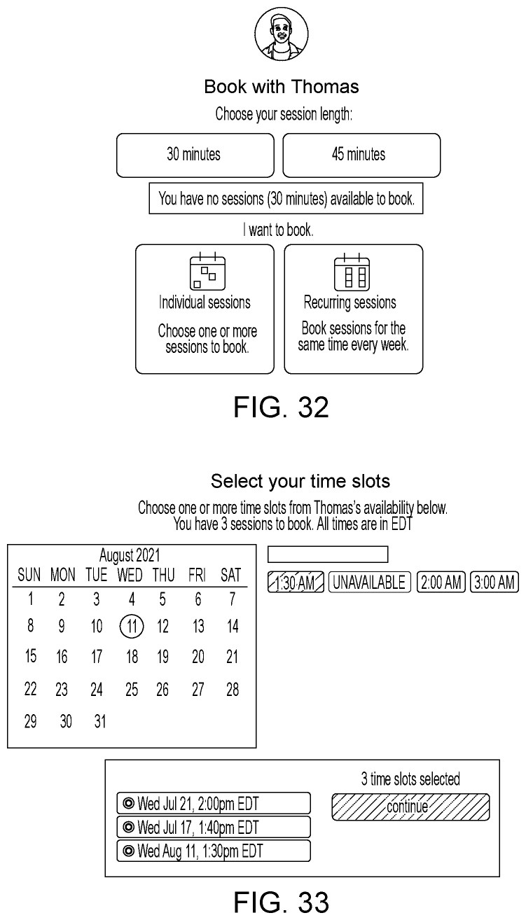

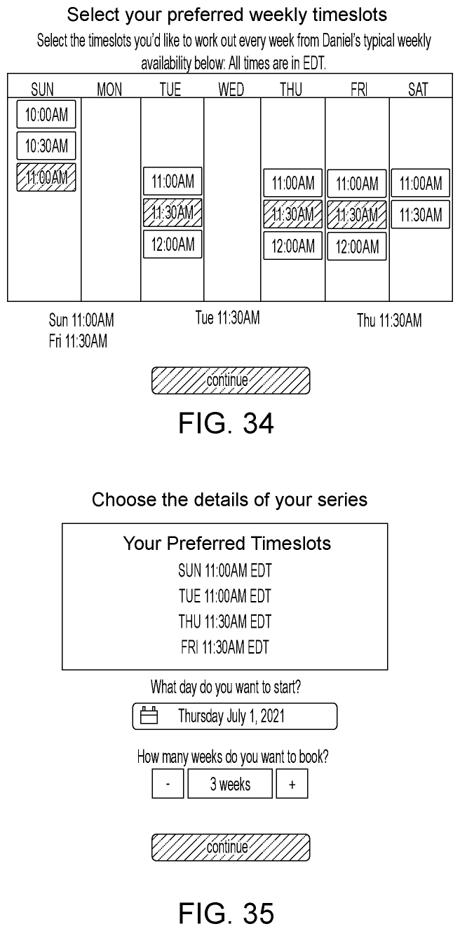

FIG. 32 presents an exemplary trainer session reservation interface according to an embodiment. Upon clicking on a trainer, the client user may be greeted with two different ways of reserving: individual sessions, or recurring sessions. FIG. 33 presents an exemplary trainer session reserving interface for individual sessions. When reserving individual sessions, a client user can select sessions one at a time. Individual sessions are suited for choosing dates at random or on specific dates. A client user may view a selected trainer's calendar and select dates / times that fit their schedule. FIG. 34 presents an exemplary trainer session reservation interface for recurring sessions according to an embodiment. Reserving recurring sessions allows a client user to select typical dates and times that they would like to have sessions at on a weekly basis, by viewing the selected trainer's typical weekly availability.

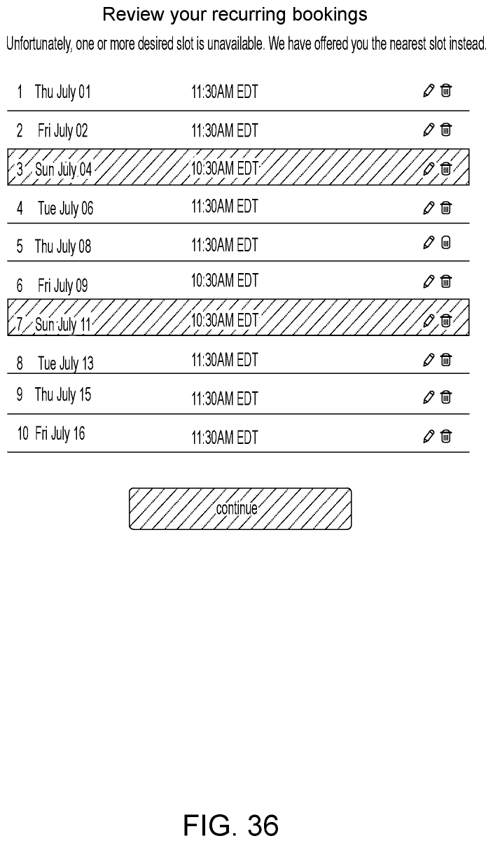

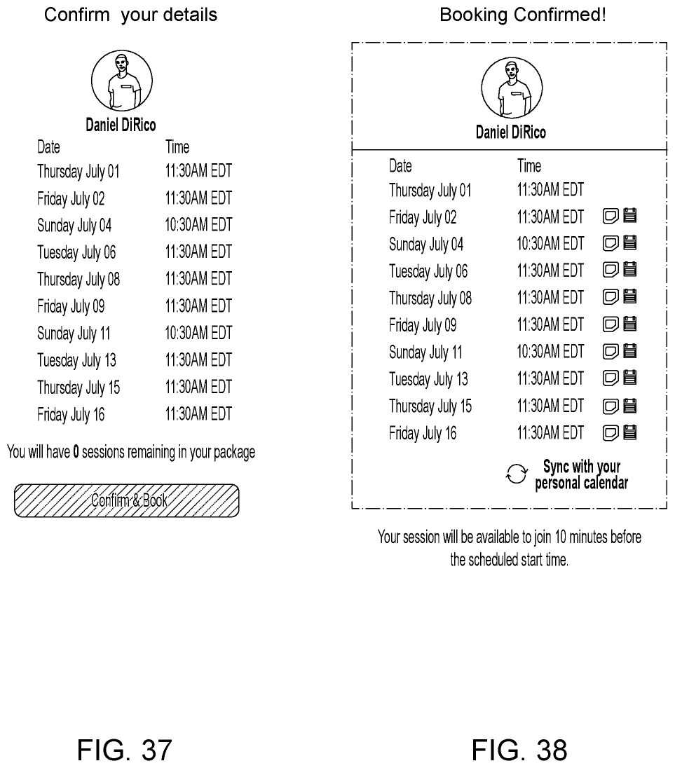

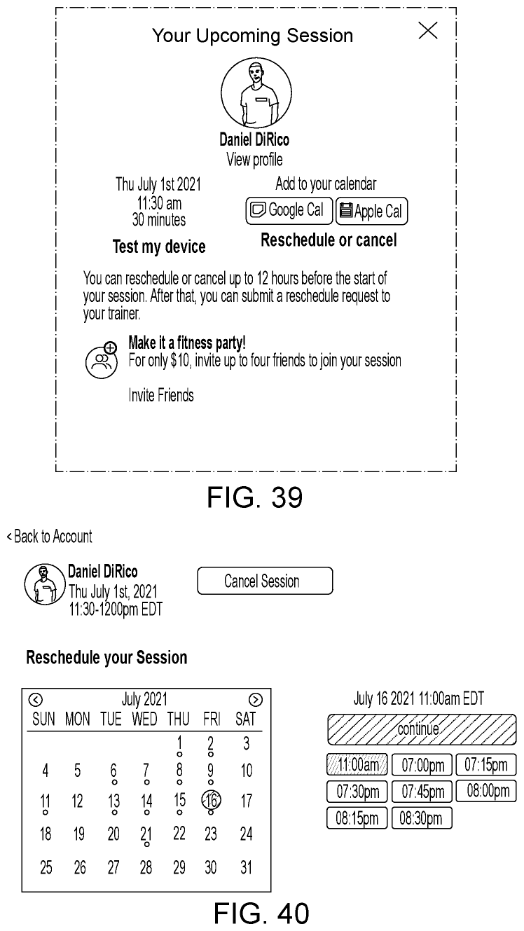

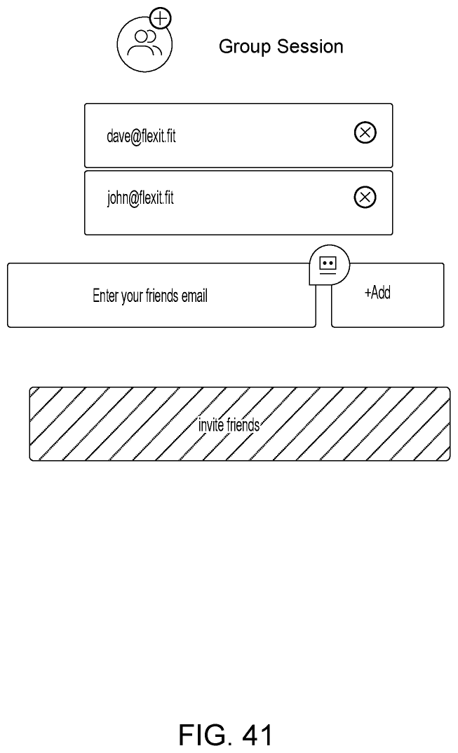

FIG. 35 presents an interface for recurring sessions where a client user may select how many weeks they would like to train for, limited by how many sessions in their plan they have on their account. The client user may then view a list of suggested sessions (FIG. 36) that meet their selected criteria, may edit any session within that list, and can then complete the reservation of the series of sessions (FIGS. 37 and 38). A client user can view details about individual sessions (FIG. 39), or choose to reschedule recurring and non-recurring sessions or cancel if necessary (FIG. 40). To reschedule a recurring or non-recurring session, a client user may click on a reschedule button within the manage session modal of a specific reservation. The client user can choose another date/time or choose to cancel the session entirely. Alternatively, the client user may choose to convert the session to a group session, as shown in FIG. 41. Within the manage session modal, a client user can convert their session to a group session, allowing up to four people to join in their session. This enables client users to invite their friends to sessions so that they can all enjoy the same experience together.

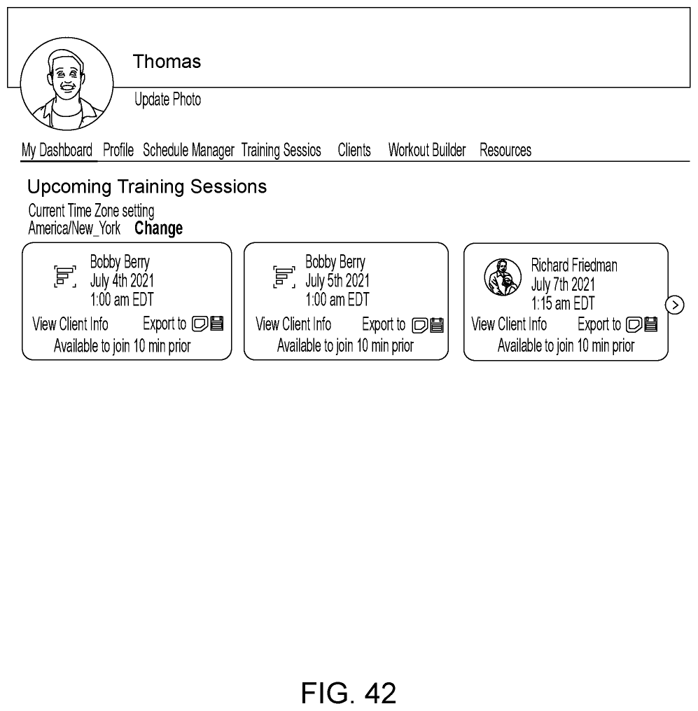

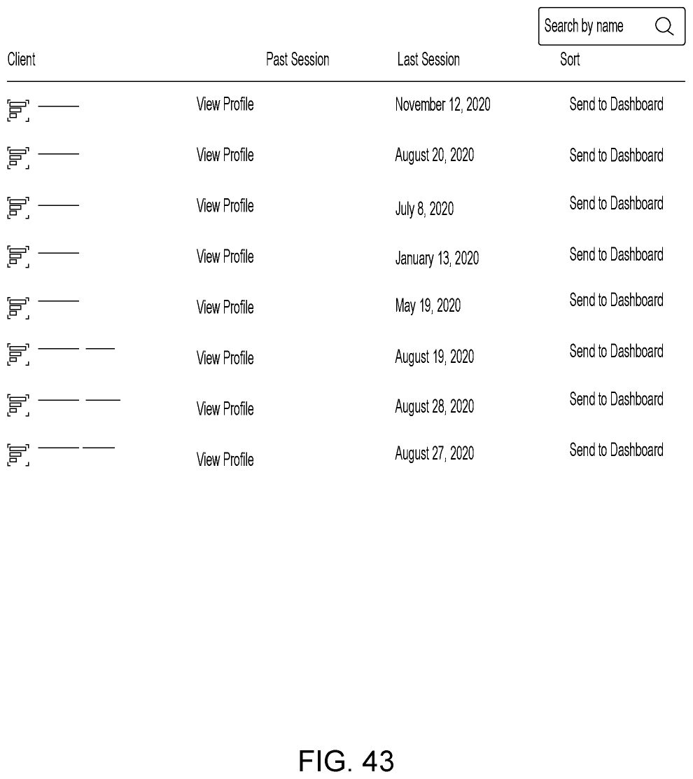

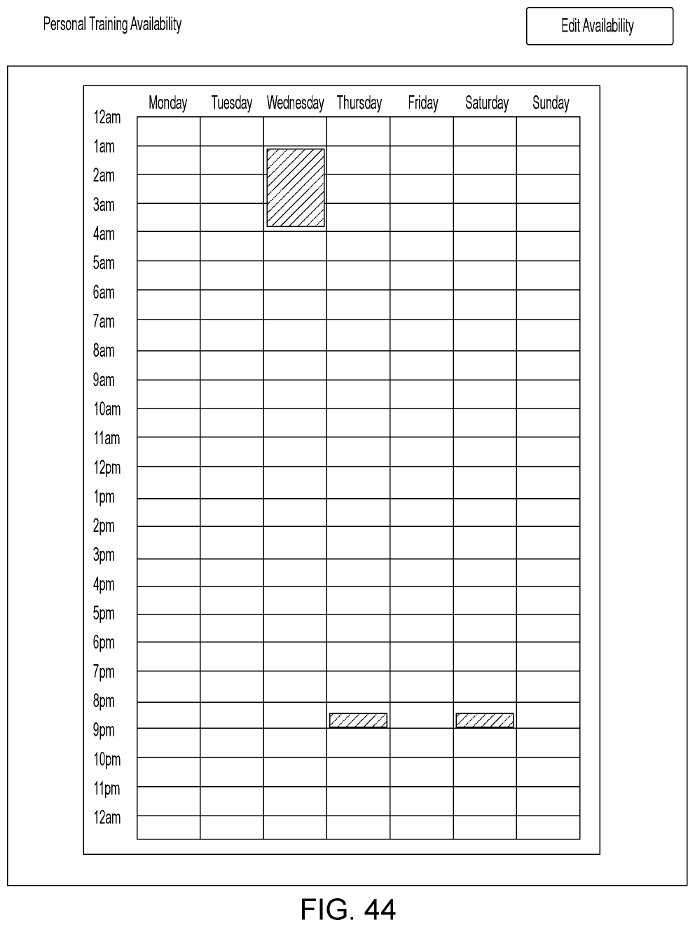

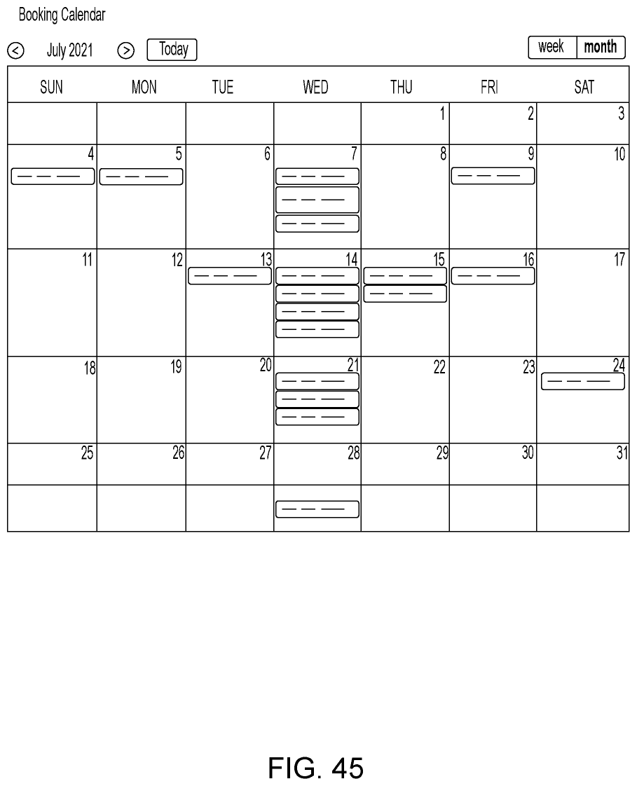

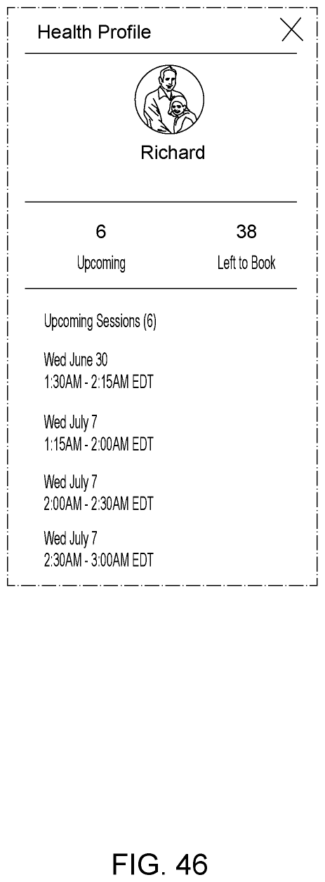

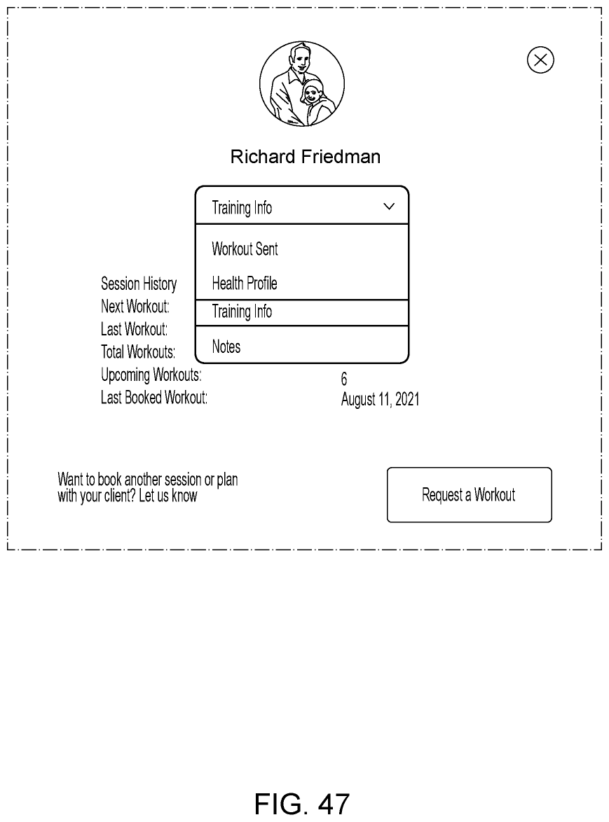

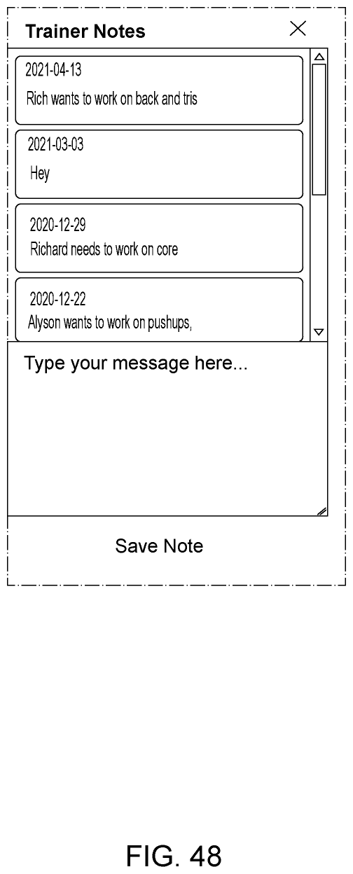

FIG. 42 presents an exemplary trainer account view according to an embodiment. A trainer account view may allow a trainer to manage and view information about their clients (FIG. 43), view upcoming sessions and set their availability (e.g., FIG. 44), view their calendar (e.g., FIG. 45). The trainer user may view health profiles of clients which may include fitness goals, equipment, and client users' upcoming sessions with a trainer (FIG. 46) and workout history (e.g., FIG. 47). A trainer may also create and view daily notes about each session and / or progress of clients, as shown in FIG. 48.

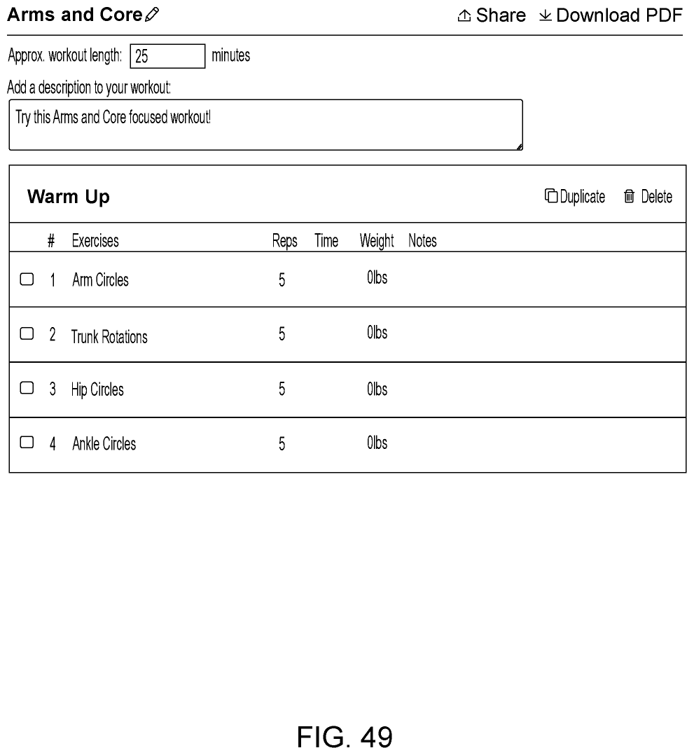

The trainer account view may further include a workout builder as presented in FIG. 49 according to an embodiment. A workout builder may allow trainer users to send client users fully customizable workouts for the client users to do on their own, but tailored to the client users' needs by their trainer. Trainer users can select from a full library of workouts with (and without) video demonstrations and set detailed info such as weight, time, reps and notes about each exercise.

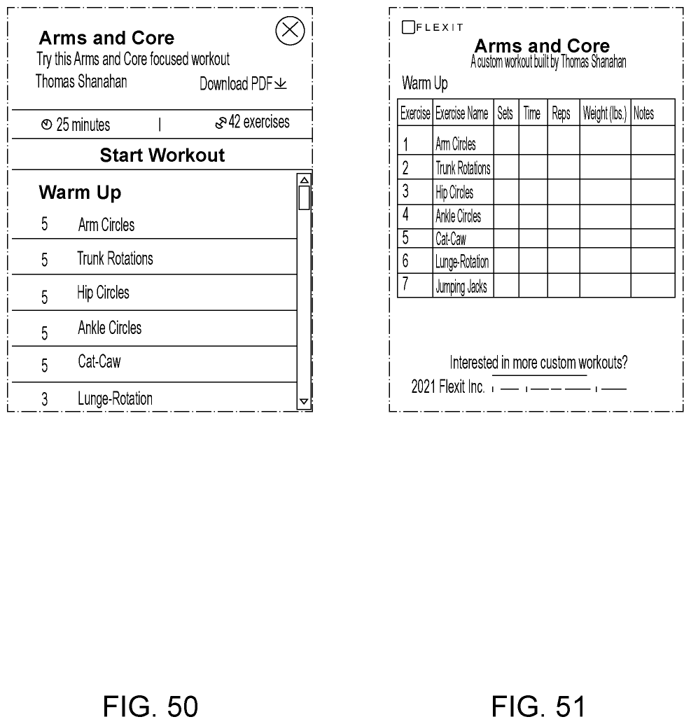

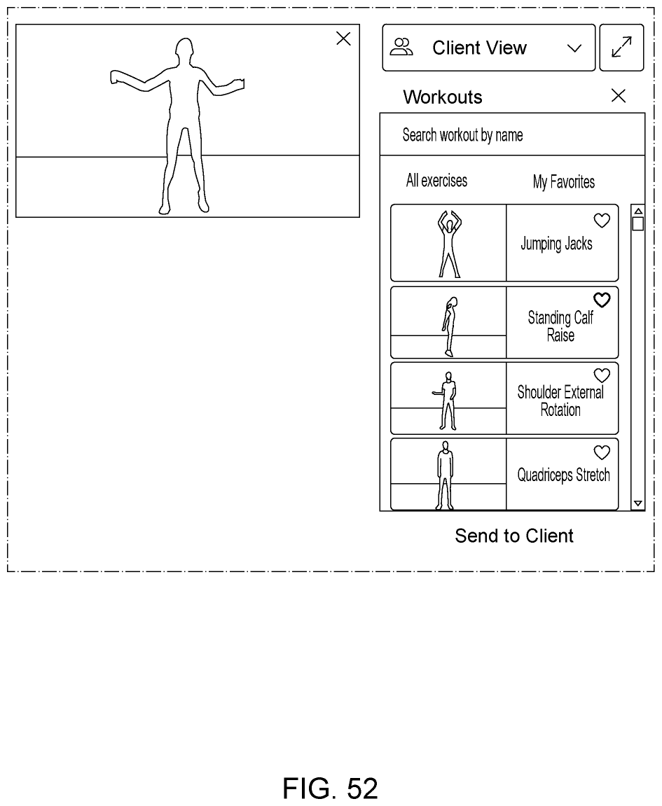

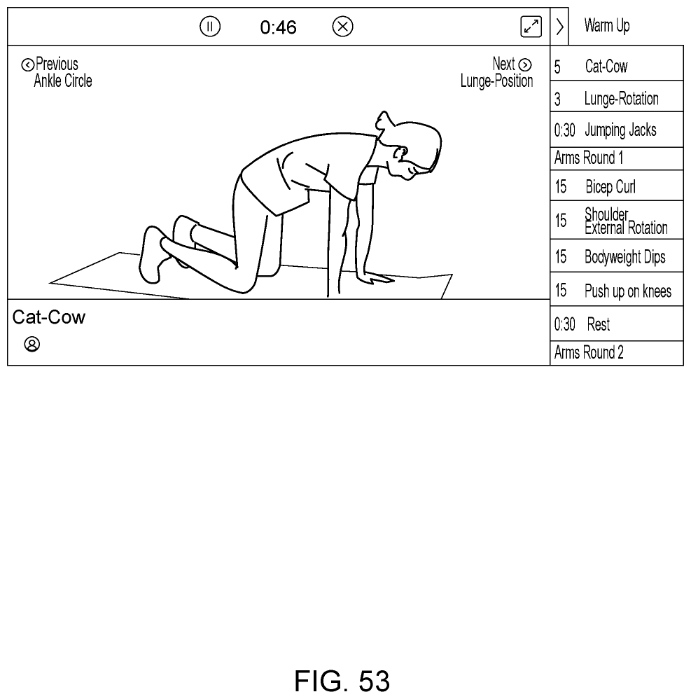

FIGS. 50 and 51 present exemplary client user views generated by a workout builder. Client users can begin a workout at any time or choose to download the workout as a document file, e.g., a portable document format (“PDF”). FIG. 52 presents an exemplary interactive workout video gallery from an in-session workout builder according to an embodiment. A client user side of the disclosed workout builder allows client users to view an interactive workout in real time, with the exercises appearing as videos. A trainer can show and send workout videos that are featured in a workout builder as a means of demonstrating a workout to a client user. Referring to FIG. 53, a workout “comes to life” with a timed client user workout, demonstrating each exercise for the client user to do according to the time specified by the trainer for the workout. Client users may also pause the workout and return to it later at their convenience.

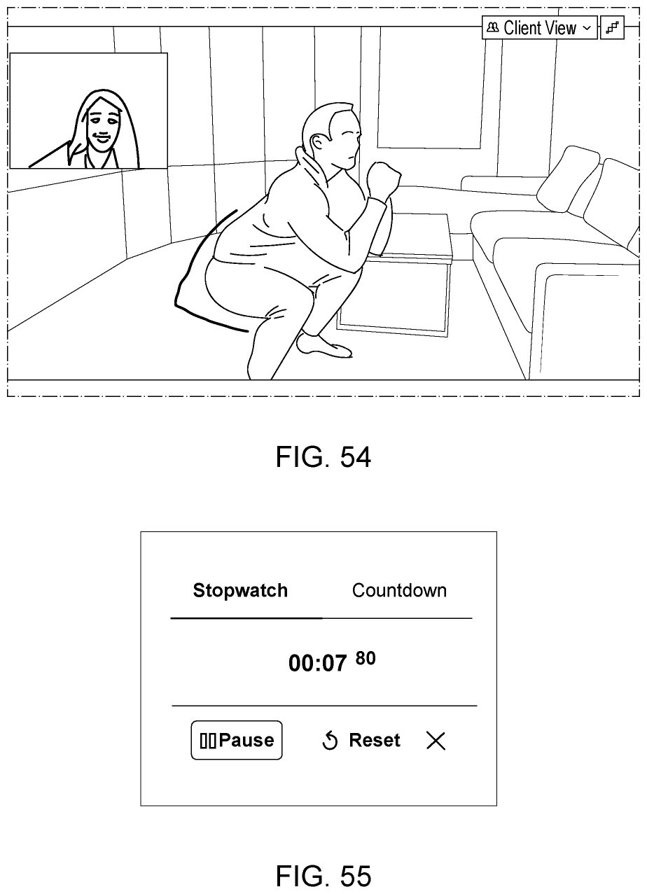

FIG. 54 presents an exemplary real-form correction screen according to an embodiment. Trainer users may create real-form correction screens by drawing or adding shapes to a session screen as a tool for pointing out mistakes/form/posture, and show in real time to the client user, or take a snapshot and send to the client user. Additionally, the real-form correction screen may be used for on-screen prompts to indicate workout instructions in real-time (e.g., targets for a client user to jump to). Trainer users can also share their music (from their device) directly with the client to create a customized workout experience. The session screen may also include an on-screen stopwatch which may also serve as a countdown timer (FIG. 55) for trainer users to show client users how much time is left in an exercise.

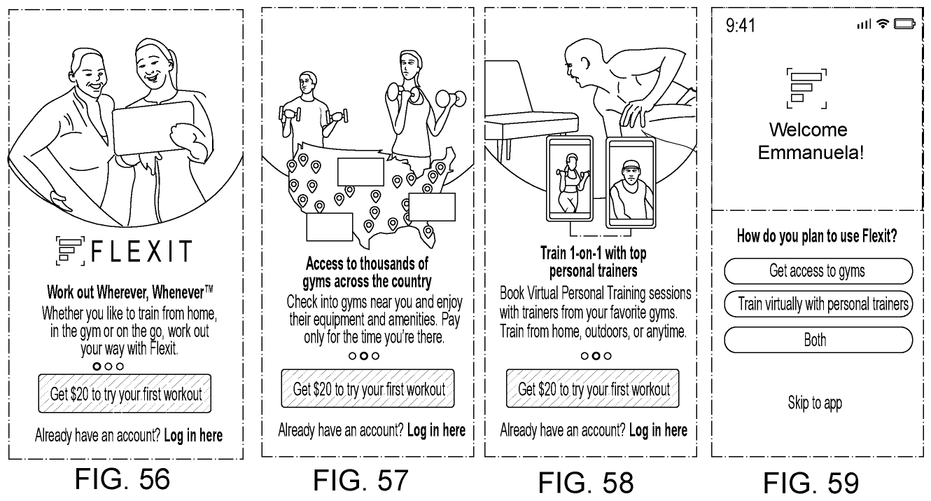

FIGS. 56 through 59 present exemplary onboarding screens of a virtual personal training system application according to an embodiment. Features provided by the disclosed website may also be available through a virtual personal training system application that can be installed and executed on a client device. The illustrated onboarding screens may direct client users to log in or create an account (users can also log in using their Apple, Facebook, or Google accounts via SSO), and get greeted with how they would like to use the virtual personal training system. Functionality of the virtual personal training system application may be identical to those provided through the website of the virtual personal training system.

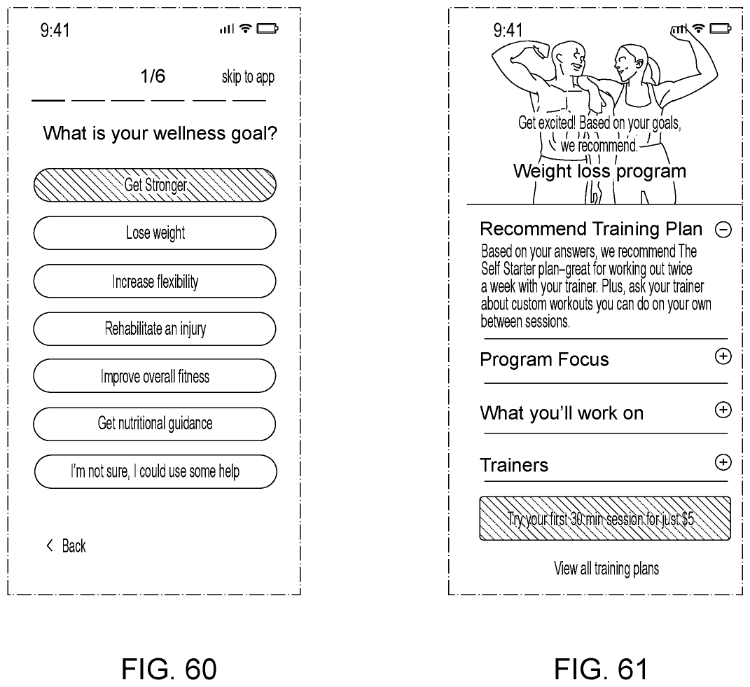

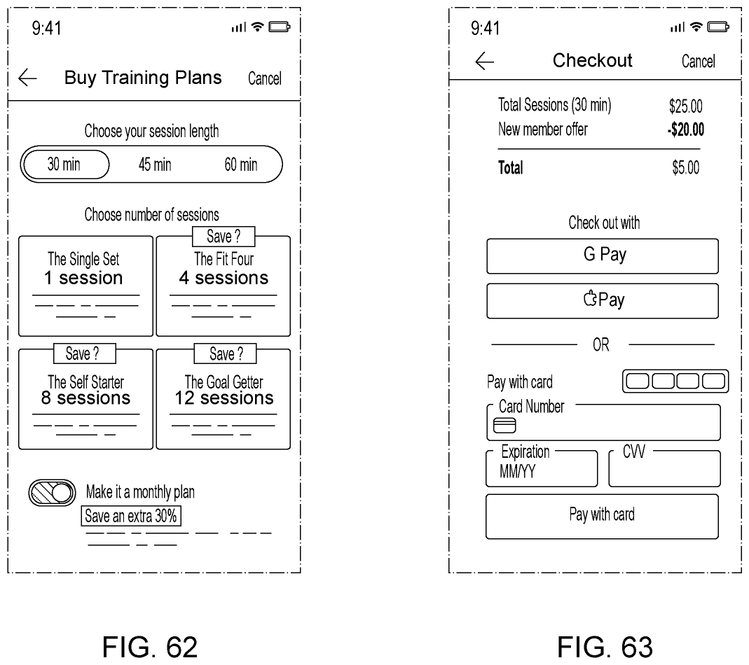

FIG. 60 presents an exemplary quiz generated by a virtual personal training system application according to an embodiment. A client user may be prompted with a quiz where answers to the quiz may be used by the virtual personal training system application to suggest a training plan and trainers based on the results of the quiz, as illustrated in FIG. 61. Client users may be prompted to purchase a training plan package based on the suggestions from the quiz (FIG. 62). Training plan packages may also be purchased as a recurring plan (e.g., monthly). Upon selecting a training plan, the client user may be prompted to enter payment and begin the reservation process (FIG. 63).

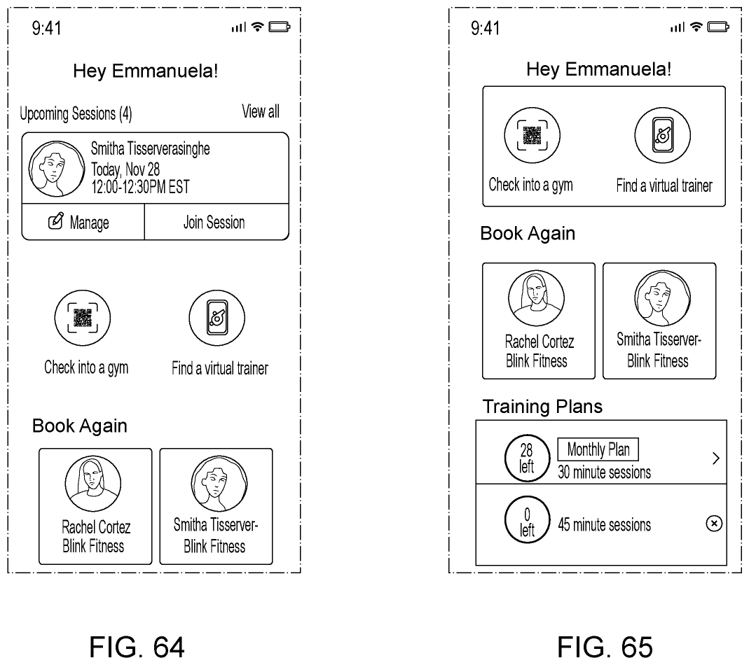

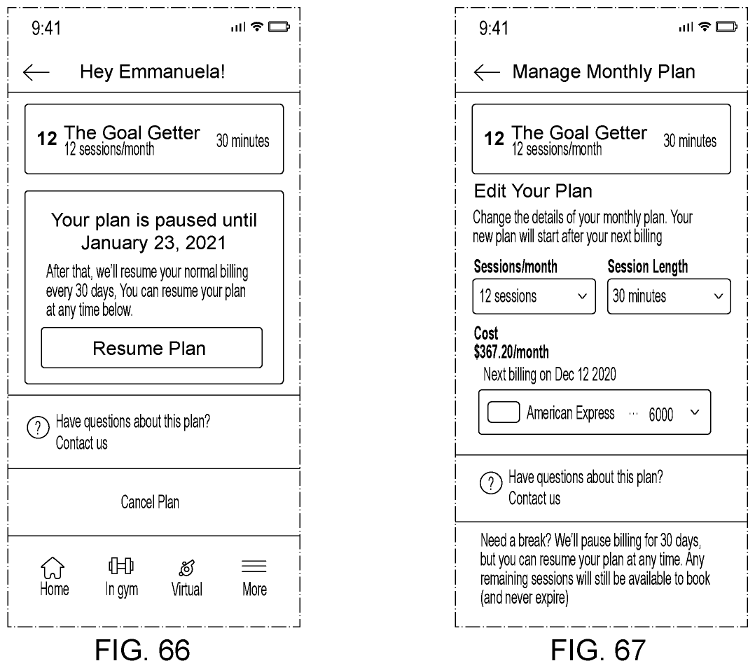

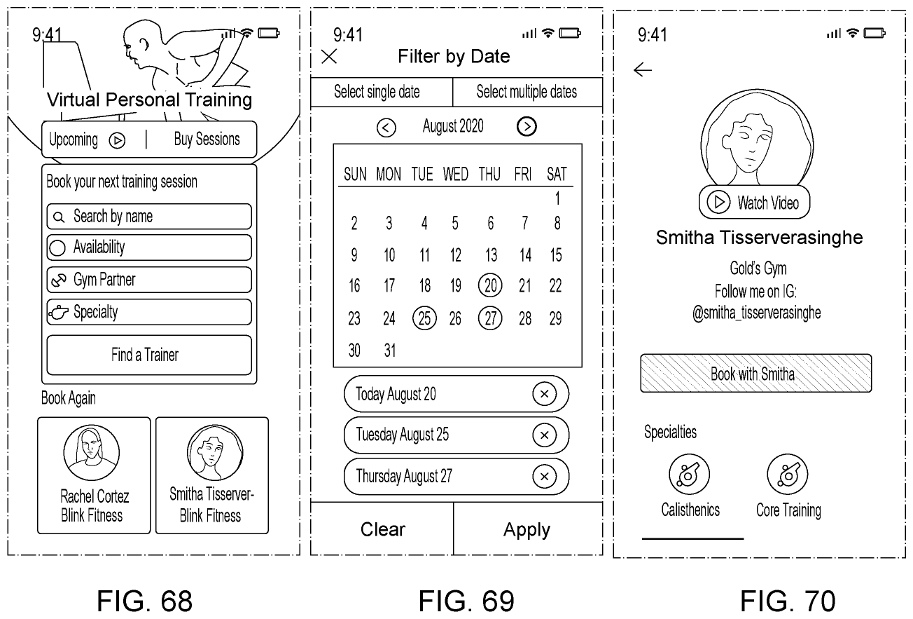

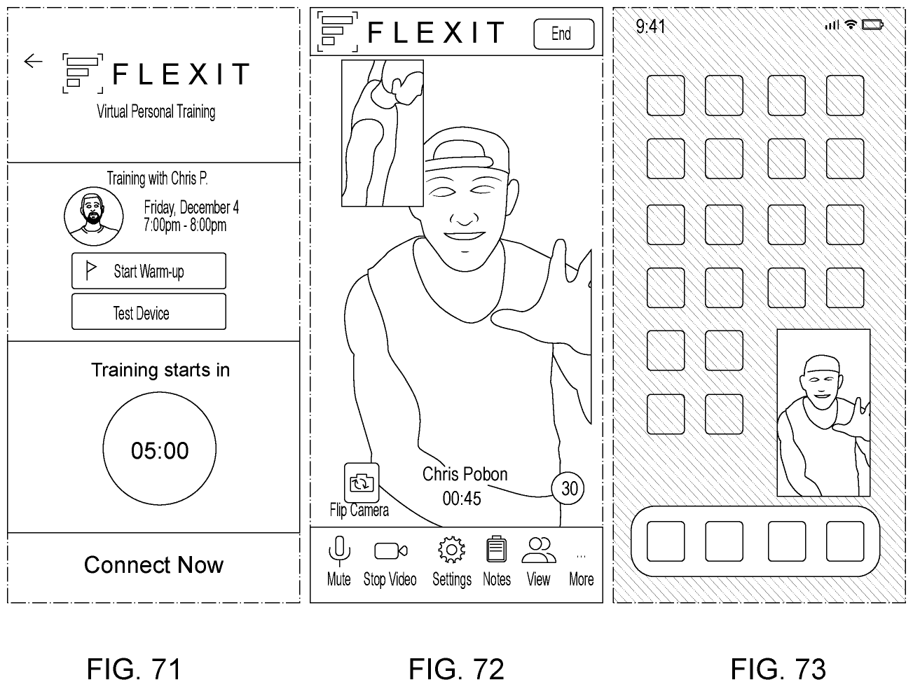

FIGS. 64 and 65 present an exemplary client user dashboard on a virtual personal training system application according to an embodiment. The client user dashboard may allow users to view their upcoming sessions and training plans. FIGS. 66 and 67 present exemplary screens for viewing and managing training plans through a virtual personal training system application according to an embodiment. Client users can view and manage training plans that they purchased in the application or via website and change, pause, or cancel the training plans. FIGS. 68 through 70 present exemplary screens for reserving training sessions through a virtual personal training system application according to an embodiment. Client users can search by a series of dates and times to view trainer availability. The client user can view the trainers' intro video, profile, specialties, and certifications, and then click to reserve a time slot with a trainer (with or without a training plan). FIGS. 71 through 73 present exemplary screens for joining a session through a virtual personal training system application according to an embodiment. Referring to FIG. 71, upon joining a session, the client user can choose to start a warm-up session, and test their device. Once the client user is ready, they may click the “Connect Now” and they will see their trainer. FIG. 72 presents an exemplary session screen according to an embodiment. In-session features may include changing orientation, in-session chat, and picture-in-picture. FIG. 73 presents an exemplary picture-in-picture view where the session screen may be displayed in a floating or pop-up window over another application or screen.

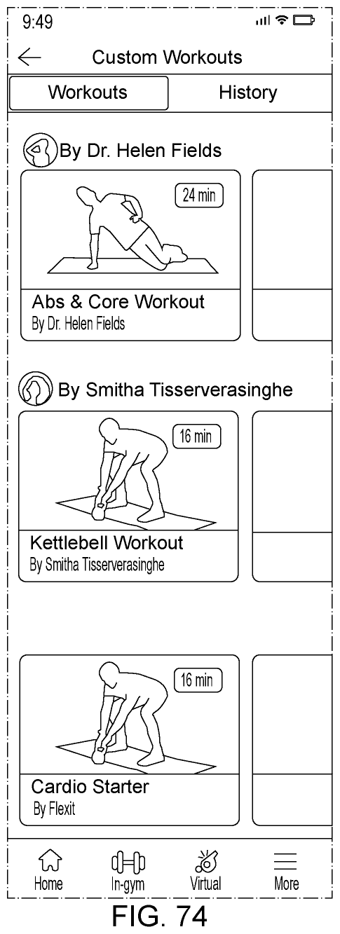

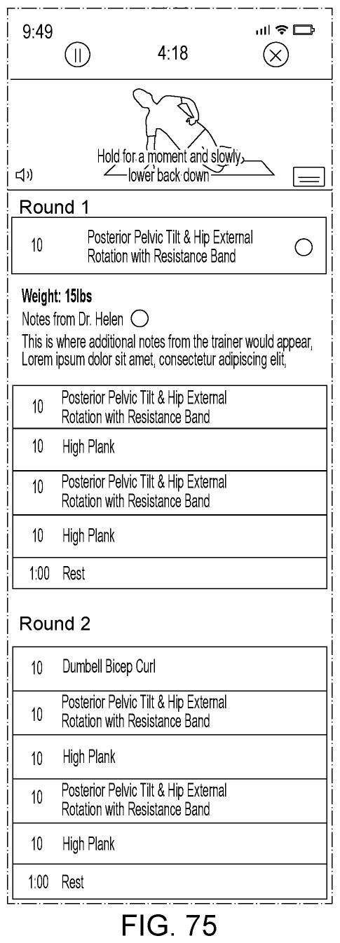

FIGS. 74 and 75 present exemplary interactive workout videos from a workout builder according to an embodiment. A trainer can create workouts to be shared with client users (these may include videos as a means of demonstrating exercises)when not in a session.

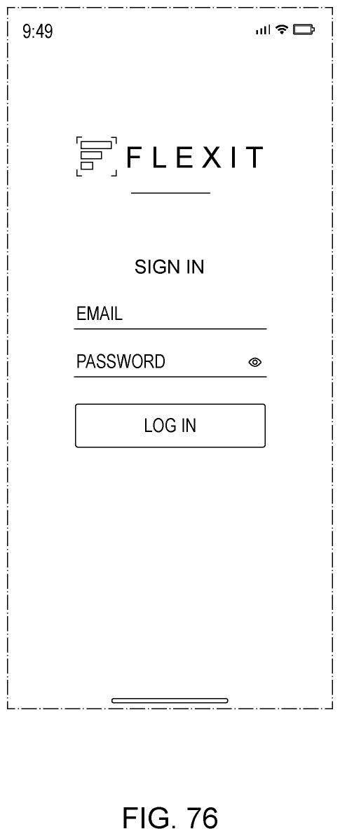

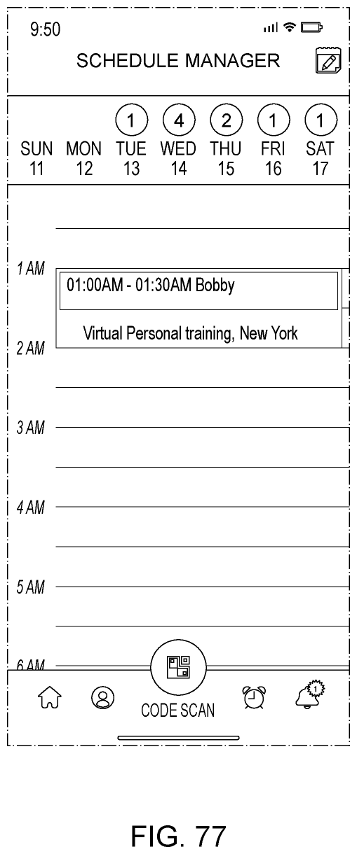

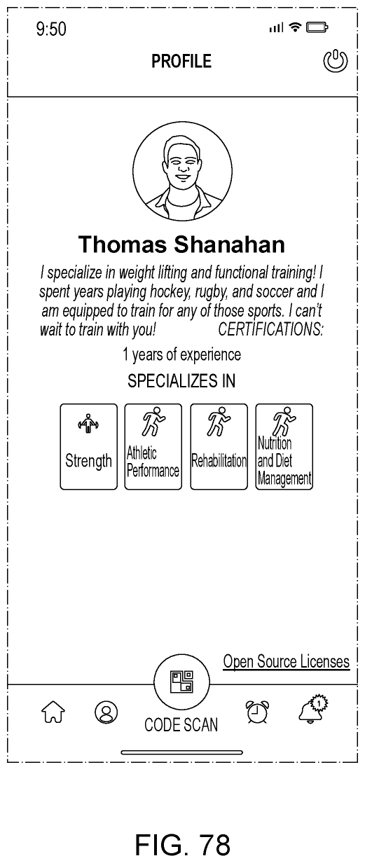

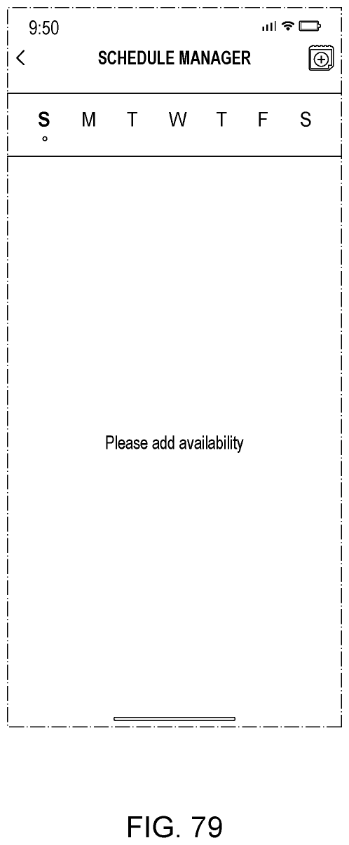

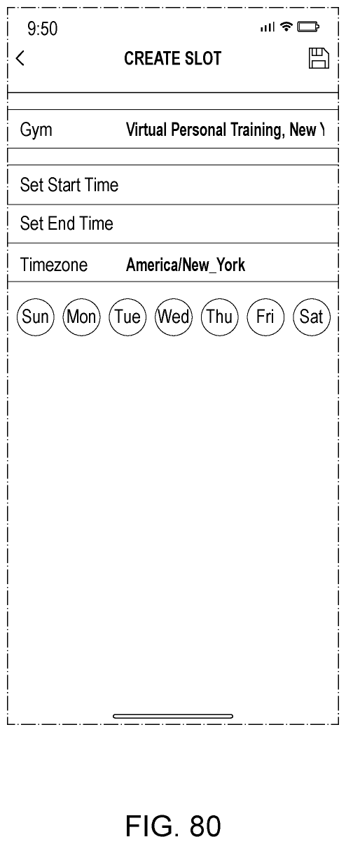

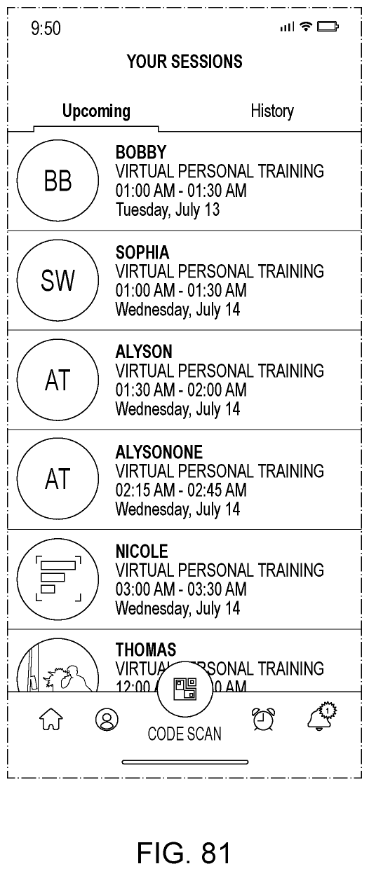

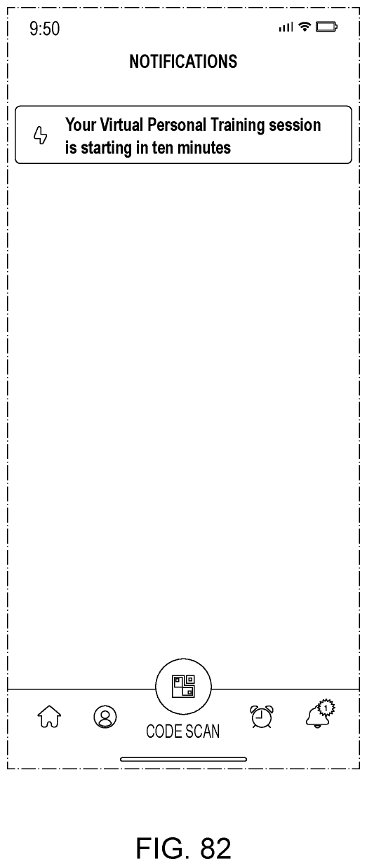

FIGS. 76 through 82 illustrate exemplary screens generated by a virtual personal training system trainer application according to an embodiment. Trainer users can log in to their accounts in the same manner they can on via the disclosed virtual personal training website, as shown in FIG. 76. Referring to FIG. 77, trainer schedules can be viewed including a trainer user's available time blocks and session that have been booked with the trainer user. FIG. 78 presents an exemplary screen generated by the virtual personal training system trainer application where trainer users can view and edit their profiles from within the application. Trainer users may also view and edit their availability from within the virtual personal training system trainer application, as shown by FIGS. 79 and 80. Trainer users can view upcoming and historical sessions that have been booked with them (FIG. 81). The virtual personal training system trainer application may also generate notifications that can alert the trainer users of sessions booked and changes to existing sessions, as shown in FIG. 82. Trainer users can also take sessions from within the application in the same way they can on the virtual personal training website and with much of the same functionality.

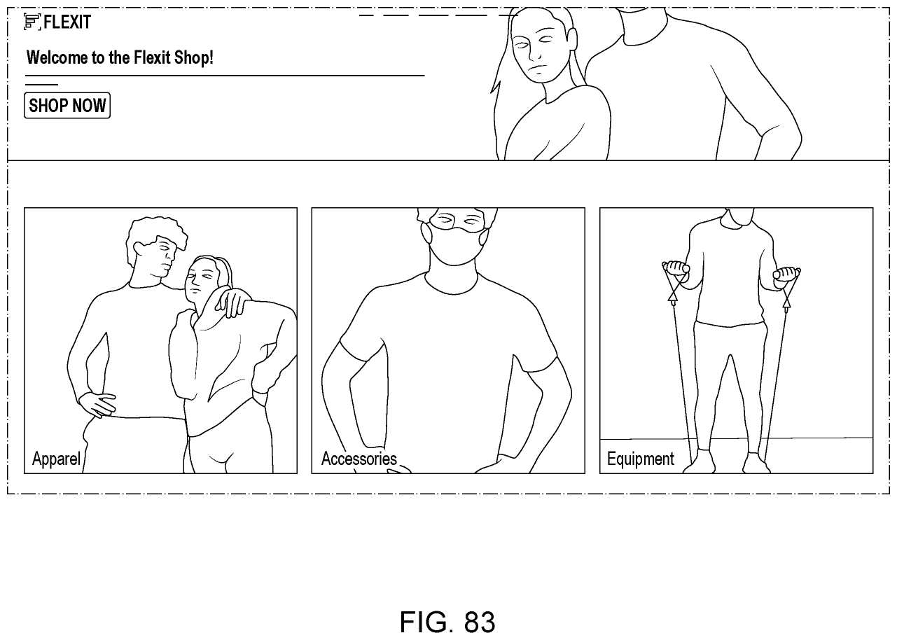

FIG. 83 presents an exemplary virtual storefront according to an embodiment. The virtual personal training system may allow users to purchase equipment, apparel, and supplements/food from a virtual storefront either through the disclosed website or application. Trainer users may recommend products or bundles that include several items that might be suited for their client users from the virtual storefront. The disclosed virtual personal training system may include a nutrition integration with the virtual storefront that allows trainer users and nutrition professionals to recommend specific supplements and/or meals for client users as well as create meal plans for them. Such meal plans may provide guidance to user clients looking to improve their eating habits and may include specifics around what foods to eat on certain days.

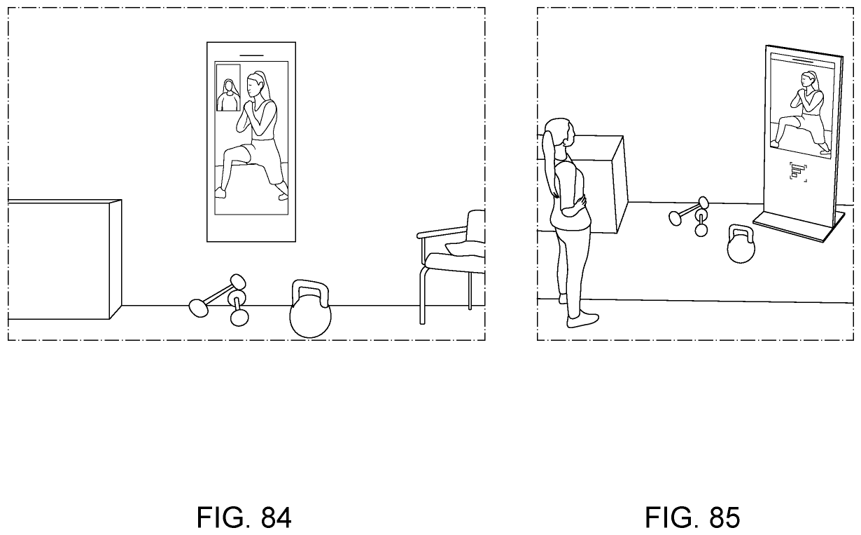

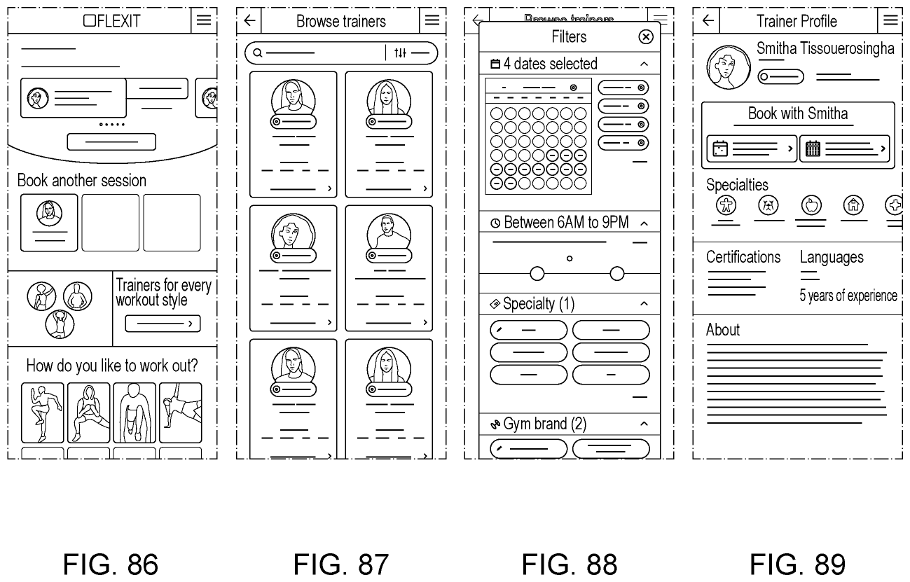

FIGS. 84 and 85 present an exemplary client devices according to an embodiment. The client devices 70 and 80 may comprise hardware that is designed/built for the delivery of virtual personal training and to create immersive experiences that effectively bring a trainer into a client user's presence, even when the two individuals are not physically in the same space. The client devices 70 and 80 may execute a virtual personal training system application as disclosed above. FIGS. 86 through 89 present exemplary screens of a virtual personal training system application executed on a wall, mountable, or standing client device according to an embodiment. The wall, mountable, or standing client device may comprise a screen with a camera or any large format piece of hardware for delivery of virtual personal training. A user client may view their upcoming sessions (FIG. 86), browse trainers (FIG. 87), reserve sessions (FIG. 88), and view trainer profiles (FIG. 89).

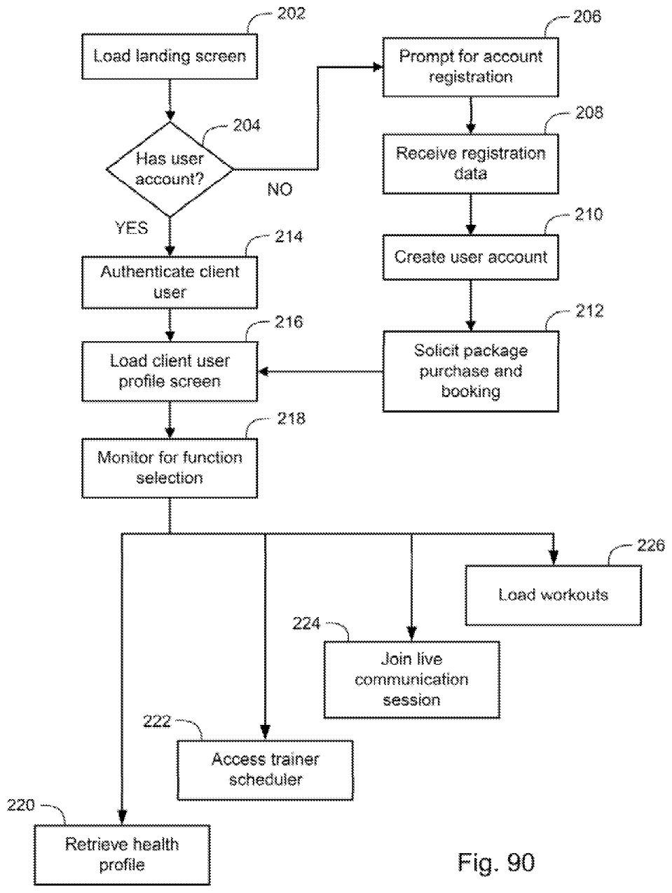

FIG. 90 illustrates a flowchart of a method for virtual personal training according to an embodiment. A virtual personal training landing screen is loaded to a client device by a server, step 202. The landing screen may comprise a web page or application screen that is presented to the client device for accessing a virtual personal training system. The landing screen may include links or buttons configured to receive and transmit to the server, a client user selection to log in or create an account. The server may receive the client user selection from the client device and determine whether the client user has a user account, step 204.

If the client user selection indicates that the user does not have a user account, the client user is prompted to register for an account, step 206. Registration data is received from the client device, step 208. The registration data may include information, such as name, phone number, email address, and how the client user heard or came about the web page or application. A user account is created based on the registration data, step 210. The client device may be solicited with options for method of payment, session package purchase, or a monthly training plan, step 212.

Upon package purchase and booking (step 212) or authentication of the client user (e.g., receiving username/email and password) for an existing user account (step 214), a client user profile screen associated with the user account is loaded to the client device, step 216. The client user profile screen may include information of upcoming sessions, a monthly calendar, and training plans. The client user profile screen is monitored for function selection from the client device, step 218. Function selection may comprise requesting any one of retrieve health profile (step 220), access trainer scheduler (step 222), join live communication session (step 224), or load video workouts, (step 226). Retrieving a health profile may comprise retrieving data associated with a client user to track their progress and log their measurements. The trainer scheduler may be used to reserve one or more sessions with trainer users. The client user may join live communication sessions with trainer users from the client user profile screen. The client user may also access interactive workouts uploaded by trainer users, with exercises appearing as videos. Client users can begin and complete the interactive workouts at any time.

FIGS. 1 through 90 are conceptual illustrations allowing for an explanation of the illustrative embodiments. Notably, the figures and examples above are not meant to limit the scope of the illustrative embodiments to a single embodiment, as other embodiments are possible by way of interchange of some or all of the described or illustrated elements. Moreover, where certain elements of the illustrative embodiments can be partially or fully implemented using known components, only those portions of such known components that are necessary for an understanding of the illustrative embodiments are described, and detailed descriptions of other portions of such known components are omitted so as not to obscure the illustrative embodiments. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the illustrative embodiments encompass present and future known equivalents to the known components referred to herein by way of illustration.

It should be understood that various aspects of the embodiments could be implemented in hardware, firmware, software, or combinations thereof. In such embodiments, the various components and/or steps would be implemented in hardware, firmware, and/or software to perform the functions of the illustrative embodiments. That is, the same piece of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the illustrative embodiments as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the illustrative embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the illustrative embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A method, in a data processing system comprising a processor and a memory, for virtual personal training, the method comprising:
loading, by a server, a virtual personal training landing screen to a client device;
receiving, by the server, login information of a user account from the client device;
authenticating, by the server, a client user based on the login information;
loading, by the server, a client user profile associated with the user account; and
monitoring, by the server, for function selection from the client device, the function selection including requesting one of retrieving a health profile, accessing a trainer scheduler, joining a live communication session, and loading video workouts.

2. The method of claim 1 wherein the client user profile screen includes information of upcoming sessions, a monthly calendar, and training plans.

3. The method of claim 1 wherein retrieving the health profile comprises retrieving data associated with the client user to track progress and log measurements.

4. The method of claim 1 wherein accessing the trainer scheduler comprises reserving one or more sessions with trainers.

5. The method of claim 1 further comprising generating a real-form correction screen that allows a trainer client device to draw or add shapes to a session screen as a tool for emphasizing mistakes, form, posture, and show in real time to the client user.

6. The method of claim 1 further comprising loading a trainer account view.

7. The method of claim 6 wherein the trainer account view includes client management, upcoming sessions, a trainer calendar, availability setting, and client information including profiles, trainer notes, health profile, and workout history.

8. A virtual personal training system comprising:
a conference server coupled to the server, the conference server configured to connect at least one client device to a trainer device in a live audio/video communication session based on a schedule;
a server coupled to one or more client devices and one or more trainer devices, the server configured to:
receive a request from the at least one client device to reserve the live audio/video communication session;
create a reservation in the schedule based on the request; and
instruct the conference server to join the at least one client device to the trainer device in the live audio/video communication session.

9. The virtual personal training system of claim 8 further comprising the server configured to generate a trainer search page including a browse trainers option to search for trainers.

10. The virtual personal training system of claim 9 wherein the trainer search page includes trainer introduction videos and trainer profiles.

11. The virtual personal training system of claim 8 further comprising the server configured to generate reservations for individual sessions or recurring sessions.
